(19) United States
(12) Patent Application Publication
(10) Pub. No.: US 2026/0239125 A1
(43) Pub. Date: Aug. 13, 2026

(54) METHODS AND APPARATUS FOR CONDUCTING HANDOVER DURING TRANSMISSION OF INTERDEPENDENT DATA

(71) Applicant: InterDigital Patent Holdings, Inc., Wilmington, DE (US)

(72) Inventors: Oumer TEYEB, Montreal (CA); Jaya RAO, Montreal (CA); Tejaswinee LUTCHOOMUN, Montreal (CA); Martino FREDA, Laval (CA)

(21) Appl. No.: 19/156,130

(22) PCT Filed: Feb. 13, 2024
(86) PCT No.: PCT/US2024/015463

§ 371 Date: Aug. 13, 2025

Related U.S. Application Data
(60) Provisional application No. 63/445,646, filed on Feb. 14, 2023.

(51) Int. Cl. H04W 36/00; H04L 69/322

(52) U.S. Cl. CPC H04W 36/0072; H04L 69/322; H04W 36/0077

(57) ABSTRACT

The disclosure pertains to procedures, methods, architectures, apparatus, systems, devices, and computer program products for, and/or directed to the execution of handover between a source cell and a target cell in a wireless network when interdependencies exist between data packet units being transmitted when handover is triggered.

### CROSS-REFERENCE TO RELATED APPLICATIONS

This application claims the benefit of U.S. Provisional Patent Application No. 63/445,646 filed Feb. 14, 2023, which is incorporated herein by reference.

### INCORPORATION BY REFERENCE

The following documents are incorporated by reference in their entirety: 3GPP TR 26.928—Technical specification Group Services and System Aspects, Extended Reality (XR) in 5G, Release 16, V16.0.0; 3GPP TR 38.835—Technical Specification Group Radio Access Network, Study on XR enhancements for NR, Release 18, V1.0.0; 3GPP TR 23.700-60, Technical Specification Group Services and System Aspects, Study on XR and media services (Release 18) (V2.0.0); 3GPP TS 38.300-NR and NG-RAN Overall Description Stage 2 (V16.1.1).

### FIELD

This disclosure pertains to procedures, methods, architectures, apparatus, systems, devices, and computer program products for, and/or directed to the execution of handover between a source cell and a target cell in a wireless network when interdependencies exist between data packet units being transmitted when handover is triggered.

### BACKGROUND

Conditional handover (CHO) solves some of the main issues of legacy handover, such as failures due to late handovers (e.g., a wireless transmit-receive unit not sending the measurement report on time to trigger the handover, the WTRU not receiving the handover command on time, etc.).

However, there may still be some issues with CHO if the WTRU has active Extended Reality (XR) applications.

There is a need to further improve the conditional handover process.

### SUMMARY

There are disclosed embodiments of methods, as described in the following and as claimed in the appended claims.

There are disclosed embodiments of a WTRU, as described in the following and as claimed in the appended claims.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a is a diagram illustrating multiple data bursts, each with multiple PDU sets of different types;

FIG. 3 is a signal flow diagram illustrating signal flow for an exemplary conditional handover;

FIG. 4 is a signal flow diagram illustrating an exemplary DAPS HO procedure;

FIG. 5 is a diagram illustrating various forwarding configurations for data units;

FIG. 6 is a flow chart illustrating an exemplary process for a WTRU to execute handover when interdependencies exist between data packet units of a PDU set or data burst being transmitted when handover is triggered in accordance with embodiments;

FIG. 7 is a flow chart illustrating an exemplary process for a WTRU to modify the CHO triggering conditions based on certain conditions related to ongoing PDU sets or data bursts further being fulfilled in accordance with embodiments;

FIG. 8 is a flow chart illustrating an exemplary process for a WTRU to perform DAPS HO in accordance with embodiments;

FIG. 9 is a flow chart illustrating an exemplary process for a WTRU to release radio resources to a source cell responsive to a handover in accordance with embodiments;

FIG. 10 is a sequence chart of an exemplary embodiment; and

FIG. 11 is a flowchart of a method according to an exemplary embodiment.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

### Example Communications System

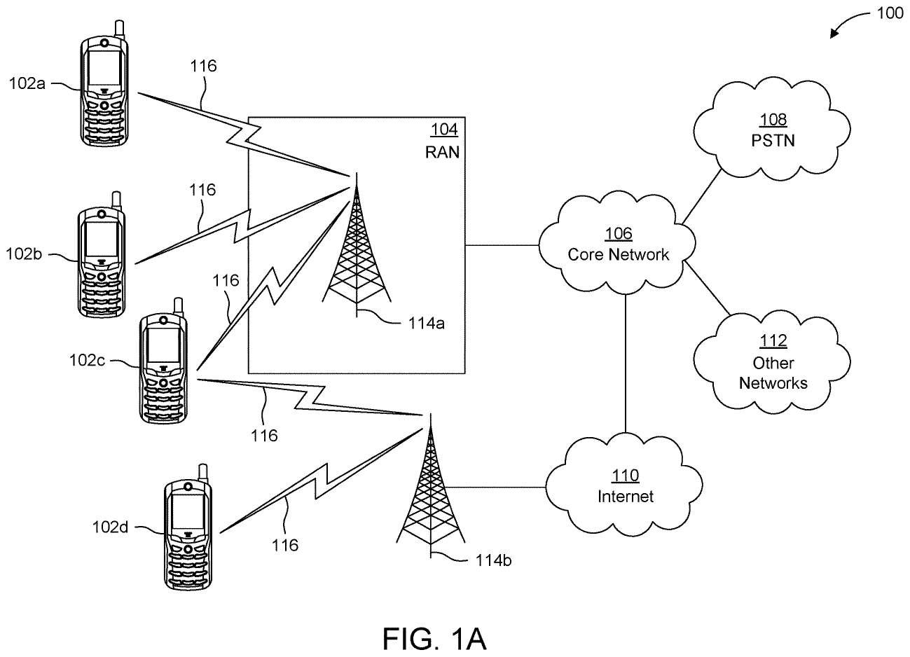

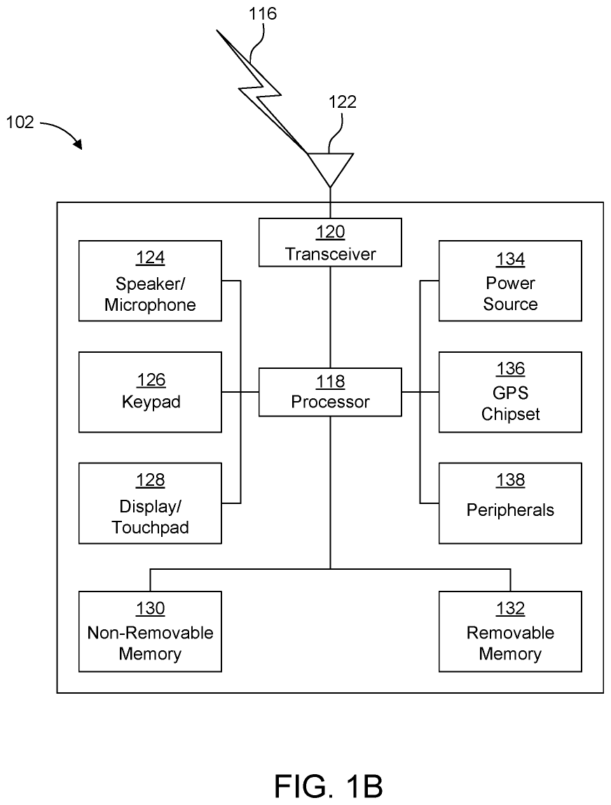

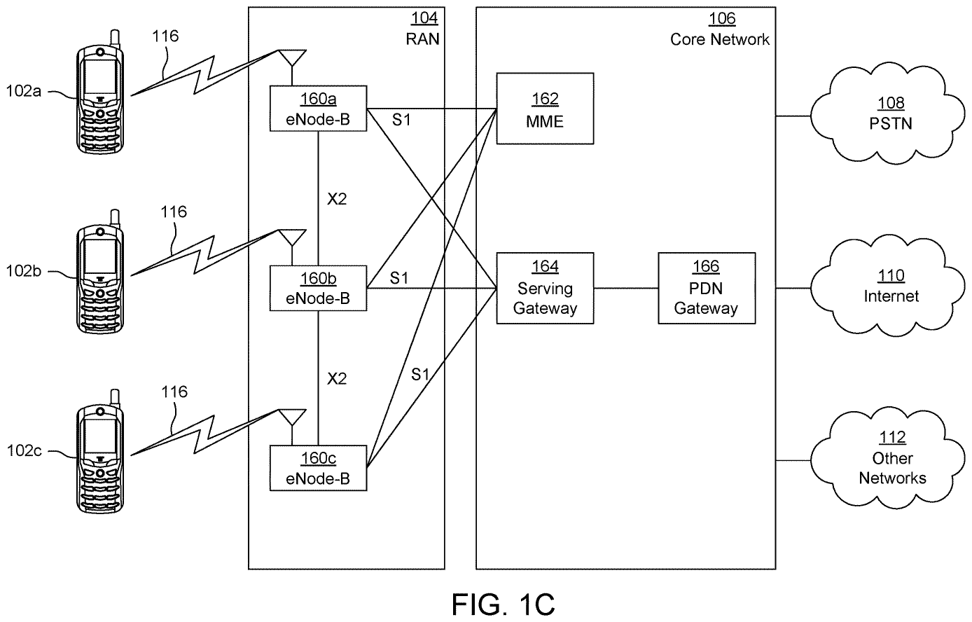

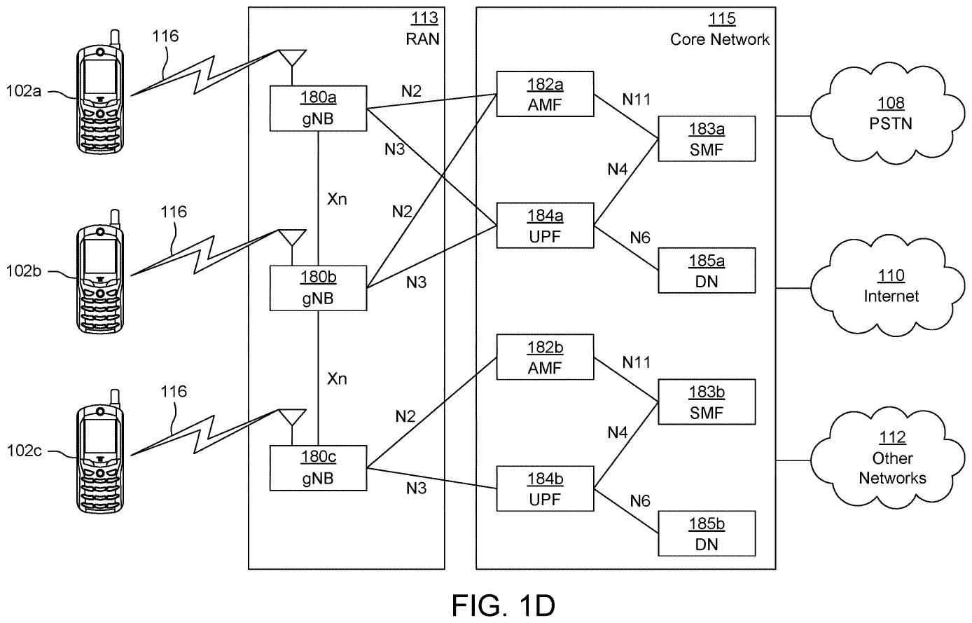

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors.

Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication.

Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Extended Reality

The term extended Reality (XR) is an umbrella term for different types of immersive experiences including Virtual Reality (VR), Augmented Reality (AR), and Mixed Reality (MR) and the realities interpolated among them.

Virtual Reality (VR) is a rendered version of a delivered visual and audio scene. The rendering is designed to mimic the visual (e.g., stereoscopic 3D) and audio sensory stimuli of the real world as naturally as possible to an observer or user as they move within the limits defined by the application.

Augmented Reality (AR) is when a user is provided with additional information or artificially generated items or content overlaid upon their current environment.

Mixed Reality (MR) is an advanced form of AR where some virtual elements are inserted into the physical scene with the intent to provide the illusion that these elements are part of the real scene.

XR may include all real-and-virtual combined environments and human-machine interactions generated by computer technology and wearables.

The notion of immersion in the context of XR applications/services refers to the sense of being surrounded by the virtual environment as well as providing the feeling of being physically and spatially located in the virtual environment. The levels of virtuality may range from partial sensory inputs to fully immersive multi-sensory inputs leading to a virtual reality practically indiscernible from actual reality.

XR devices may be typically associated with capabilities that offer various degrees of spatial tracking. XR devices may be equipped with various sensors to enable spatial tracking, for example, monocular/stereo/depth cameras, radio beacons, GPS, inertial sensors, etc. Possibly such spatial tracking may be performed at different levels, e.g., 3 Degrees of Freedom-DoF (i.e., rotational motion along X, Y and Z axis), 6 DoF (i.e., rotational and/or translational motion around and along X, Y and Z axis). Possibly such spatial tracking may result in an interaction to experience some form of virtual content. The user may act in and/or interact with the components within extended reality. For example, the actions and/or interactions may involve movements, gestures, eye tracking, etc. Spatial tracking is an important enabler for immersive XR experience. For example, some form of head and/or motion tracking may ensure that the simulated visual and audio components from the user perspective are updated to be consistent with user's movements. Imprecise and/or delayed spatial tracking may lead to a sensation of discomfort and/or motion sickness for the user.

In this disclosure, a WTRU may refer to any XR device/node which may come in a variety of form factors. A typical WTRU (e.g., XR WTRU) may include, but not be limited to, the following: Head Mounted Displays (HMD), optical see-through glasses and camera see-through HMDs for AR and MR, mobile devices with positional tracking and cameras, wearables, etc. In addition to the above, several different types of XR WTRUs may be envisioned based on XR device functions (for example, as display, camera, sensors, sensor processing, wireless connectivity, XR/Media processing and power supply) to be provided by one or more devices, wearables, actuators, controllers, and/or accessories. One or more devices/nodes/WTRUs may be grouped into a collaborative XR group for supporting XR applications/experience/services.

### PDU Set and Data Burst

In current 5GS, the Quality of Service (QoS) Flow is the finest granularity of QoS differentiation in the Packet Data Unit (PDU) Session. The 5G QoS characteristics are determined by the 5G QoS Identifier (5QI). This implies that each packet in a QoS flow is treated according to the same QoS requirements.

For XR/media services, a group of packets are used to carry payloads of a PDU Set (e.g., a frame, video slice/tile). A PDU Set is composed of one or more PDUs carrying the payload of one unit of information generated at the application level (e.g., a frame or video slice).

In media layer, packets in such a PDU Set are decoded/handled as a whole. For example, the frame/video slice may only be decoded if all (or a certain amount) of the packets carrying the frame/video slice are successfully delivered. For example, a frame within a GOP (Group of Pictures) can only be decoded by the client if all frames on which that frame depends are successfully received. Hence the groups of packets within the PDU Set have inherent dependency on each other in media layer. In the absence of considering such dependencies between the packets within the PDU set, 5GS may perform scheduling with low efficiency. For example, the 5GS may randomly drop packet(s) but try to deliver other packets of the same PDU set which are useless to the client and thus waste radio resources.

Also, audio samples, haptics applications, or remote control operations may benefit if the 5GS considers the PDU Set characteristics. If such dependency between packets of a PDU Set (e.g., a frame/video slice) can be considered, it is possible to enhance efficiency and improve the user experience.

Thus, 3GPP is studying the required enhancements on the current 5GS QoS framework to support different QoS handling for PDU Sets. PDU Sets can carry different content, e.g., I/B/P frames, slices/tiles within an I/B/P frame, etc. For example, differentiated QoS handling is being studied where different importance of PDU Sets is considered, e.g., by treating packets (i.e., PDUs) belonging to less important PDU Set(s) differently than packets belonging to more important PDU Sets to increase resource usage efficiency.

A Data Burst is a set of data PDUs generated and sent by an application in a short period of time. A Data Burst may be composed of multiple PDUs belonging to one or multiple PDU Sets.

PDU-Set Delay Budget (PSDB) defines an upper bound for the time that a PDU-Set may be delayed between the WTRU and the N6 termination point at the User Plane Function (UPF).

PDU-Set Error Rate (PSER) defines an upper bound for the rate of PDU-Sets that have been processed by the sender of a link layer protocol (e.g., RLC layer) but where all of the PDUs in the PDU-Set are not successfully delivered by the corresponding receiver to the upper layer (e.g., Packet Data Convergence Protocol (PDCP) layer).

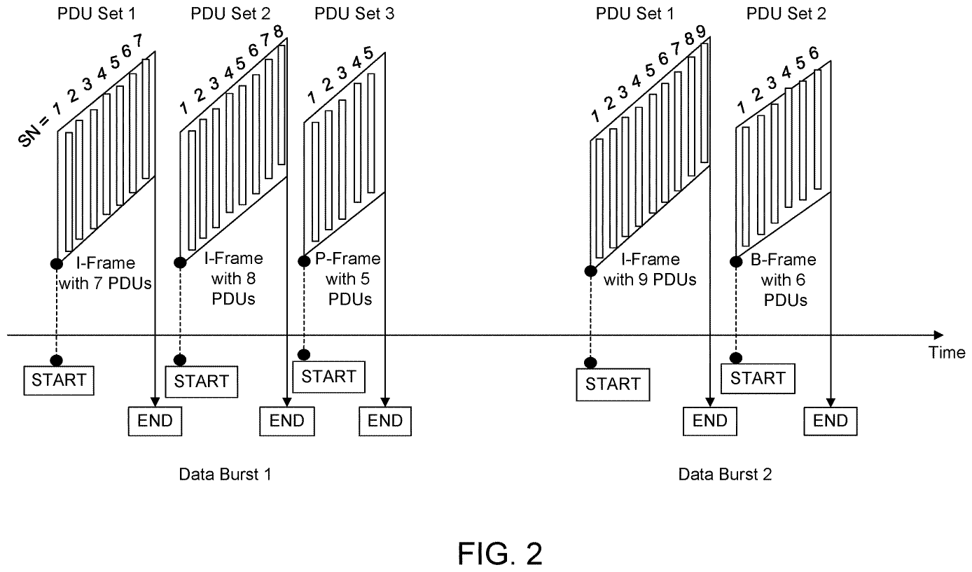

An example of multiple data bursts, each with multiple PDU sets of different types, is shown in FIG. 2.

### Measurements in NR

Measurements performed by the WTRU are used by the network for mobility decisions (e.g., handover).

In RRC_CONNECTED state, the WTRU measures one or more beams of a cell, and the measurements results (power values) are averaged to derive the cell quality. In doing so, the WTRU is configured to consider a subset of the detected beams. Filtering takes place at two different levels: at the physical layer to derive beam quality and then at the RRC level to derive cell quality from multiple beams. Cell quality from beam measurements is derived in the same way for the serving cell(s) as for the non-serving cell(s). Measurement reports may contain the measurement results of the X best beams if the WTRU is configured to do so by the gNB.

The measurement reporting configuration can be either event triggered or periodic. If it is periodic, the WTRU sends the measurement report every reporting interval (which can range between 120 ms and 30min).

For event triggered measurements, the WTRU sends the measurement report when the conditions associated with the event are fulfilled. The WTRU keeps on measuring serving and neighbor cells and compares it with the threshold or offset defined in the measurement report configuration. The report quantity/trigger for the event can be Reference Signal Received Power (RSRP), Reference Signal Receive Quality (RSRQ), or Signal to Interference and Noise (SINR).

### The Following Measurement Events Are Defined for Nr:

### Intra-RAT Events

Event A1 is when the serving cell becomes better than a threshold. Event 1A is typically used to cancel an ongoing handover procedure. This may be required if a WTRU moves towards cell edge and triggers a mobility procedure, but then subsequently moves back into good coverage before the mobility procedure has completed.

Event A2 is when a serving cell becomes worse than a threshold. Since it does not involve any neighbor cell measurements, Event A2 is typically used to trigger a blind mobility procedure, or the network may configure the WTRU for neighbor cell measurements when it receives a measurement report that is triggered due to event A2 in order to save WTRU battery (i.e., not perform neighbor cell measurement when the serving cell quality is good enough).

Event A3 is when a neighbor cell becomes offset better than the SpCell. Event A3 is typically used for handover procedures. Note that an SpCell (special cell) is the primary serving cell of either the Master Cell Group (MCG), i.e., the PCell, or Secondary Cell Group (SCG), i.e., the PSCell. Thus, in DC operation, the Secondary Node (SN) can configure an A3 event for SN triggered PSCell change. Event A3 is also used for Conditional Handover (CHO) and Continuous Packet Connectivity (CPC).

Event A4 is when a neighbor cell becomes better than a threshold. Event A4 is typically used for handover procedures which do not depend upon the coverage of the serving cell (e.g., load balancing, where the WTRU is handed over to a good neighbor cell even if the serving cell conditions are excellent).

Event A5 is when a SpCell becomes worse than threshold1 and a neighbor cell becomes better than threshold2. Like Event A3, Event A4 is typically used for handover. However, unlike Event A3, Event A4 provides a handover triggering mechanism based upon absolute measurements of the serving and neighbor cell, whereas Event A3 uses relative comparison. As such, it is suitable for time critical handover when the serving cell becomes weak and it is necessary to change towards another cell which may not satisfy the criteria for an event A3 handover.

Event A6 is when a Neighbor cell becomes offset better than an SCell. Event A6 is used for SCell addition/releasing.

### Inter-RAT Events

Event B1 is when an inter RAT neighbor becomes better than a threshold. This is equivalent to Event A4, but for the case of inter-RAT handover.

Event B2 is when a PCell becomes worse than threshold1 and an inter RAT neighbor cell becomes better than threshold2. This is equivalent to Event A5, but for the case of inter-RAT handover.

Measurement event configurations contain a time to trigger (TTT), which indicates the duration the event conditions needs to be fulfilled before the WTRU triggers the associated measurement reporting. TTT can be set to values ranging from 0 (i.e., no TTT) to several minutes (maximum in Release 16 is around 5 minutes).

### Conditional HO and CPAC in NR

Release 16 NR introduced the concept of conditional handover (CHO) and conditional PSCell Addition/Change (CPA/CPC, or collectively referred to as CPAC), having the main goal of reducing the likelihood of radio link failures (RLF) and handover failures (HOF).

Legacy LTE/NR handover is typically triggered by measurement reports, even though there is nothing preventing the network from sending a HO command to the WTRU even without receiving a measurement report. For example, the WTRU is configured with an A3 event that triggers a measurement report to be sent when the radio signal level/quality (RSRP, RSRQ, etc.) of a neighbor cell becomes better than the Primary serving cell (PCell) or the Primary Secondary serving Cell (PSCell), in the case of Dual Connectivity (DC). The WTRU monitors the serving and neighbor cells and will send a measurement report when the conditions become fulfilled. When such a report is received, the network (current serving node/cell) will prepare the HO command (basically, an RRC Reconfiguration message with a reconfiguration With Sync) and sends it to the WTRU, which the WTRU executes immediately, thereby resulting in the WTRU connecting to the target cell.

CHO differs from legacy handover in two main aspects. First, multiple handover targets are prepared (as compared to only one target in legacy case). Second, the WTRU does not immediately execute the handover as in the case of legacy handover. Instead, the WTRU is configured with triggering conditions (e.g., a set of radio conditions), and the WTRU executes the handover towards one of the targets only when/if the triggering conditions are fulfilled.

The CHO command could be sent when the radio conditions toward the current serving cells are still favorable, thereby reducing the two main points of failure in legacy handover, i.e., risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command).

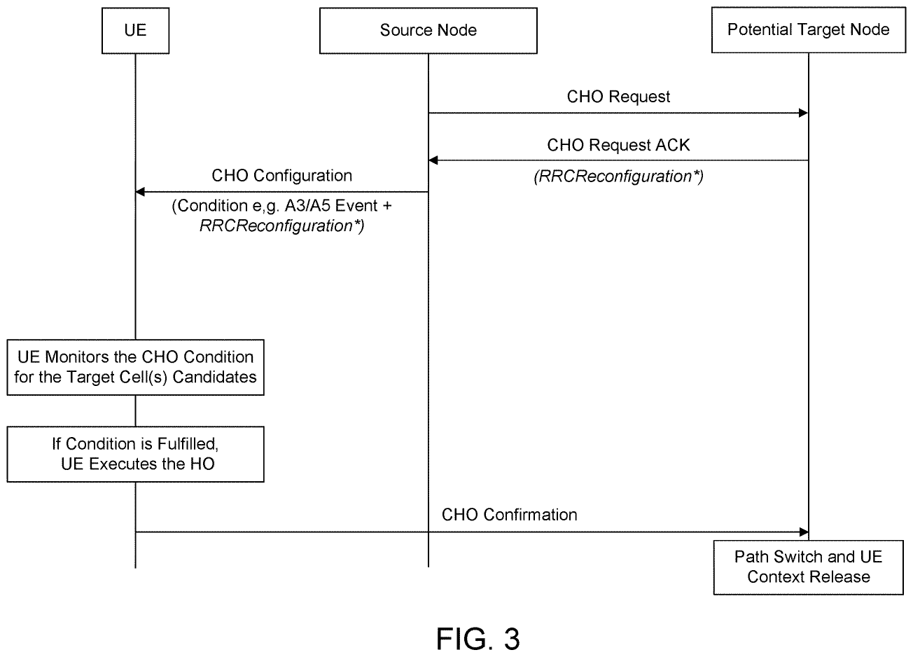

The triggering conditions for a CHO also could be based on the radio quality of the serving cells and neighbor cells, like the conditions that are used in legacy NR/LTE to trigger measurement reports. For example, the WTRU could be configured with a CHO that has an A3 like triggering condition and associated HO command. The WTRU monitors the current and serving cells and, when the A3 triggering conditions are fulfilled, instead of sending a measurement report, it executes the associated HO command and switches its connection toward the target cell. FIG. 3 is a signal flow diagram illustrating signal flow for an exemplary conditional handover.

Another benefit of CHO is in helping prevent unnecessary re-establishments in case of a radio link failure. For example, let us assume that the WTRU is configured with multiple CHO targets and the WTRU experiences an RLF before the triggering conditions with any of the targets get fulfilled. Legacy operation would result in an RRC re-establishment procedure that would have incurred considerable interruption time for the bearers of the WTRU. However, in the case of CHO, if the WTRU, after detecting an RLF, ends up in a cell for which it has a CHO associated with it (i.e., the target cell is already prepared for it), the WTRU will execute the HO command associated with this target cell directly, instead of continuing with the full re-establishment procedure.

CPC and CPA are just extensions of CHO, but in Dual Connectivity (DC) scenarios. A WTRU could be configured with triggering conditions for PSCell change or addition, and when the triggering conditions are fulfilled, it will execute the associated PSCell change or PSCell add commands.

To enable the CHO/CPAC, new conditional measurement events are defined in NR, wherein, upon the fulfillment of the conditions of the events, the associated CHO/CPAC configuration with the event is executed. These include: (1) CondEvent A3, wherein the candidate cell becomes an amount of offset better than PCell/PSCell; (2) CondEvent A4, wherein the candidate cell becomes better than a threshold; and CondEvent A5, wherein PCell/PSCell becomes worse than absolute threshold1 and the candidate cell becomes better than another absolute threshold2.

In addition to the radio condition based conditional events discussed above, location and time based conditional events have also been defined in NR (e.g., to be used in scenarios like NTN (Non-terrestrial networks), wherein the time/location of the moving satellite cells is predictable, and, as such, a WTRU can be instructed to perform a CHO/CPAC based on time or location). These include: CondEvent D1, wherein a distance between the WTRU and a reference location referenceLocation1 becomes larger than configured threshold Thresh1 and a distance between the WTRU and a reference location referenceLocation2 of conditional reconfiguration candidate becomes shorter than configured threshold Thresh2; and CondEvent T1, wherein a time measured at the WTRU becomes more than configured threshold Thresh1 but is less than Thresh2.

Like measurement reporting events, conditional event configurations also contain a time to trigger (TTT), which indicates the duration the event conditions needs to be fulfilled before the WTRU executes the CHO.

### Dual Active Protocol Stack

In Release 16, the concept of Dual Active Protocol Stack (DAPS) Handover was introduced (for both LTE and NR) in order to reduce the interruption time during handover (which, for example, could range from 30 ms to 60 ms in LTE, depending on the handover scenario), thereby ensuring that the quality of highly delay sensitive services will not be degraded because of mobility.

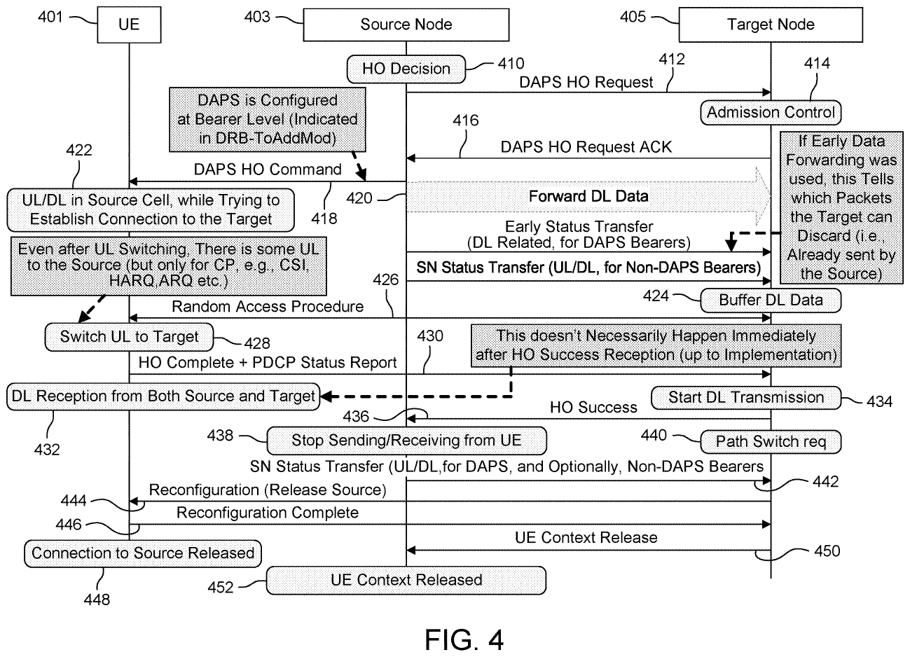

The DAPS HO procedure is illustrated in FIG. 4.

The source 403, upon deciding (410) to perform a DAPS HO, sends a DAP HO request 412 to the target 405. A DAPS HO request 412 is a handover request that includes information regarding to which DRBs the DAPS HO is to be applied (i.e., it is possible that for some DRBs, normal HO can be applied). After performing admission control (414), the target 405 responds with a HO request acknowledgement 416.

The source 403 sends a DAPS HO command 418 to the WTRU 401, which is an RRC Reconfiguration with reconfiguration WithSync that also contains an indication regarding which DRBs are to be involved in DAPS HO. The source 403 continues normal operation for UL data (i.e. forwarding it to the core network) and for DL (i.e. sending it to the WTRU), but also starts forwarding the DL data towards the target (420).

Once the WTRU 401 has managed to perform random access (RA) with the target (426), UL data transmission is switched to the target (428), but DL reception is still performed from the source. The WTRU 401 sends a HO complete 430, which is an RRC Reconfiguration Complete message, to the target 405, including the PDCP status report for those DRBs that were configured for DAPS HO. The target 405 will start sending the buffered DL data to the WTRU using the status information provided by the WTRU to avoid the sending of duplicate packets (i.e., packets forwarded from the source but now indicated to have been received by the WTRU).

The target indicates the success of the handover to the source (436), after which the source stops sending and receiving data to/from the WTRU (438). The target also initiates path switch 440 towards the core so that new DL data will be sent to the target instead of the source. The target indicates to the WTRU the DAPS HO is finalized by sending an RRC Reconfiguration message 444 that contains a daps-SourceRelease indicator, upon which the WTRU releases the connection to the source (448). The target also sends a context release message 450 to the source, so that all the WTRU context at the source gets released. The source 403 releases the context (452).

As indicated above, DAPS handover is configured on a DRB level (i.e., normal PDCP/RLC/MAC procedures applied for the bearers not configured for DAPS handover) and a handover is referred to as a DAPS handover if at least one bearer is configured for DAPS. The handover mechanism triggered by RRC requires the WTRU at least to reset the MAC entity and re-establish RLC, except for DAPS handover, where upon reception of the handover command, the WTRU: (1) creates a MAC entity for the target, (2) establishes the RLC entity and an associated logical channel for the target for each DRB configured with DAPS (hence the name dual protocol stack), (3) for the DRB configured with DAPS, reconfigures the PDCP entity with separate security and Robust Header Compression (ROHC) functions for source and target and associates them with the RLC entities configured by the source and the target, and (4) retains the rest of the source configurations until instructed to release the source Since the mobile terminal will receive user data simultaneously from both the source and target cell, the PDCP layer is reconfigured to a common PDCP entity for the source and target user plane protocol stacks. To secure in-sequence delivery of user data, PDCP Sequence Number (SN) continuation is maintained throughout the handover procedure. For that reason, a common (for source and target) re-ordering and duplication function is provided in the single PDCP entity. Ciphering/deciphering and header compression/decompression are handled separately in the common PDCP entity, depending on the origin/destination of the DL/UL packet.

CHO solves some of the main issues of legacy handover, such as failures due to late handovers (e.g., WTRU not sending the measurement report on time to trigger the handover, WTRU not receiving the handover command on time, etc.) by pre-configuring the WTRU with the handover command and associated conditions to be fulfilled (e.g., source/target radio conditions), where the WTRU executed the handover command when the conditions are fulfilled.

However, there may still be some issues with CHO if the WTRU has active XR applications, as legacy CHO only considers triggering conditions that are based on radio conditions of the source and/or target.

For example, while the WTRU is still waiting for the radio conditions for the CHO to be fulfilled (e.g., condEvent A3, where the target needs to be better than the source by a certain threshold to trigger the CHO), PDUs for a given PDU set can keep buffering (in the UL or DL) due to current load conditions at the source. This could happen even if the target radio conditions are only marginally lower than the required value to trigger the CHO and target is not loaded.

As another example, when the CHO is executed, a PDU set transmission/reception may be interrupted for a certain time (e.g., the handover interruption time, which comprises time components such as the time required by the RRC to process the HO command, time for the WTRU to perform RA/sync to the target, time to send the HO complete message, etc.). Thus, the PDU set delay budget (PSDB) of a PDU Set can be exceeded while waiting for a CHO triggering conditions to be fulfilled or while a CHO is being executed.

As discussed above, DAPS reduces service interruption time during handover by making temporary dual connectivity available with both the source and target nodes/cells. However, there may still be some UL latency/interruption because, even though the WTRU is connected to both the source and the target in the DL, the UL connection is to either the source or the target. That is, before RA is completed with the target, UL will be with the source, and after RA is completed, UL will be with the target. It should be noted that there may still be some UL signaling toward the source after the UL is switched to the target for sending some CSI feedback, HARQ ACK/NACKs, etc. However, there will be no UL data transmission via the source after the RA to the target is successful.

If a DAPS HO is initiated while there is an active XR application, a situation may arise where some of the packets belonging to one PDU set (or a given data burst) may be sent via the source and others will be sent via the target. That is, when legacy DAPS HO procedure is supported, the WTRU may only transmit any remaining PDUs of a PDU set to the target, and not to the source. This could result in the PDU set delay budget (PSDB) being exceeded, depending on several factors like the duration of the RA to the target, capacity/throughput available at the target for the WTRU immediately after handover, radio link quality between the WTRU and the target, etc.

Throughout the description herein, the following terms will be used as described hereinbelow.

The term network may include any of a base station (e.g., gNB, TRP, RAN node, access node), core network function (e.g., AMF), and application function (e.g., edge server function, remote server function), for example.

The term source refers to a node or a cell that the WTRU was originally connected to.

The term target refers to a node or a cell to which a WTRU is being handed over due to CHO/DAPS execution.

The terms conditional handover, conditional configuration, and conditional reconfiguration are used interchangeably.

The terms PDU and packet are used interchangeably.

Flows may correspond to any of: QoS flows or data flows (e.g., flow of data consisting of one or more PDUs or ADUs, which may be associated with one or more QoS requirements, e.g., latency, data rate, reliability). Different flows, possibly originating from a common application/experience source and/or intended to a common destination device/WTRU or group of associated devices/WTRU may be referred to associated flows or correlated flows.

Forwarding configuration may correspond to any of the following: radio bearers (e.g., data radio bearers (DRBs) and/or signaling radio bearers (SRBs), logical channels (LCHs), logical channel groups (LCGs), configuration parameters in the individual layers within the AS protocol stack (e.g., SDAP, PDCP, RLC, MAC, PHY, other new protocol layers), parameters associated with logical channel prioritization (LCP) (e.g., priority, PBR, BSD), BWPs, carriers, radio links/interfaces (Uu links, SLs), and radio resources (e.g., set of one or more frequency/time/spatial resources such as timeslots, subcarriers, or beams. Radio resources may also be associated with configurated grants, dynamic grants and/or any other resource grants or grant free resources).

Mapping configuration may correspond to any of the following: parameters and/or configurations associated with mapping from one or more of application data (e.g., PDU set) flows, QoS flows (e.g., associated or non-associated) and one or more radio bearers, SDAP, PDCP, LCHs, carriers or component carriers (e.g., CCs in CA configurations), BWPs, and radio links/interfaces (e.g., Uu link or sidelinks), which may be used for delivering the PDUs in UL direction or DL direction, for example.

XR/application-aware data transmissions/receptions or XR/application-aware QoS handling may correspond to any of the following:
a) PDU set handling: A PDU set (e.g., media unit, video frame) may comprise of one or more PDUs. A PDU set may be associated with PDU set-level QoS requirements (e.g., data rate, latency, reliability), which may be applicable for one or more or all PDUs associated with a PDU set. The different PDUs in a PDU set may be associated with individual PDU-level QoS requirements. Such associations and inter-dependencies may be visible to the AS-layers (e.g., with associated IDs) and/or handled at the AS layers with the awareness of the association during data transmission and reception;
b) Application/high layer importance/priority: The different PDUs in a PDU set or all PDUs in a PDU set may be associated with different application/high layer importance/priority values. Such importance value may correspond to spatial importance (e.g., spatial position of a video frame whose data is carried by the PDU/PDU set, where PDUs/PDU sets carrying Field of View (FoV) spatial positions may be associated with higher spatial importance than non-FoV spatial positions) or temporal importance (e.g., time sequence of the video frame whose data is carried by the PDU/PDU set, where PDUs/PDU sets carrying base video frames such as I-frame may be associated with higher temporal importance than differential video frames such as P-frame/B-frame). Such importance values may be visible to the AS layers (e.g., with associated IDs/markers/indications), possibly enabled by application awareness, during data transmission and reception;
c) QoS flow handling: The PDUs/PDU sets of an application may be encoded and delivered by the application to the WTRU (in UL) or the network (in DL) via one or more QoS/data flows. In this regard, the different QoS flows carrying the PDUs/PDU sets associated to an XR application/experience may be visible to the AS-layers (e.g., with associated IDs) and/or handled at the AS layers with the awareness of the association during data transmission and reception The phrase “the WTRU is in the middle of transmitting/receiving packets belonging to a certain PDU set or data burst” refers to the scenario where certain PDUs of the PDU set or the data burst are already transmitted/received or being transmitted/received, while others are still pending in the WTRU/gNB buffers. The term “ongoing PDU set or data burst” also is used to refer to the outstanding PDUs (i.e., not transmitted successfully by the WTRU for the UL case and not received successfully by the WTRU for the DL case) within a PDU set or data burst. The above phrases and terms may also apply to the scenario where certain packets associated with any of PDU sets, data bursts, and QoS flows are pending at the application/higher layers and/or yet to arrive at the lower layer buffers at the WTRU/gNB for UL/DL transmission. The WTRU/gNB may be aware of such packets pending at the application/higher layers based on application/NAS layer indications and/or markings in the previously received packet headers, for example. The above phrases and terms may also apply for non-XR traffic, which may consist of one or more standalone PDUs in any QoS flows without any association with PDU sets, media/video frames or data bursts.

### Configuration Aspects

The WTRU may receive configuration information for supporting any of the procedures, mechanisms, rules, actions, etc., discussed herein related to mobility enhancements. The WTRU may receive configuration information for supporting any of the procedures, mechanisms, rules, actions, etc., discussed below at any time while the WTRU is in CONNECTED mode, or when the WTRU is resuming the connection from suspended state or establishing the connection from IDLE state or re-establishing the connection after a failure.

The configuration information may be received by the WTRU from the network during any of the following: with the CHO configuration or reconfiguration, with the DAPS HO command, and outside the CHO/DAPS configuration (e.g., any RRC reconfiguration message).

The WTRU may receive any of the configuration information via any of the following, for example: broadcast signaling (e.g., SIB); dedicated signaling (RRC signaling and/or messages, e.g., RRC Reconfiguration, CHO configuration, DAPS HO command, RRC measurement reporting configuration, RRC Resume, RRC Setup, etc.); Non-AS (NAS) layer signaling (e.g., a PDU Session Establishment Response or a PDU Session Modification Command); and application layer signaling/messages.

The WTRU may get information about the size of PDU sets/data bursts (e.g., size of frame and/or PDU and/or PDU-set and/or group of PDU-sets) and other information such as PDU set type, importance, etc., by several means.

For example, the WTRU may receive indications from the application/higher layers about the size of the PDU-set. In one example, the indication may come in the packet header of the first packet/PDU in the PDU-set.

For example, the WTRU may receive indications from the application that the WTRU may use to infer the size of the PDU-set. In an example, the WTRU may receive indications about the first and the last packet in the PDU-set, which may be indicated in the headers of the first and the last packet for example.

For example, the WTRU may receive size information on a more granular level. In an example, the WTRU may receive indications from the application about the typical size of different frames (e.g., I-frame, P-frame, B-frame). The first/last packet in the PDU-set may contain information indicating its type (e.g., corresponding to an I-frame or P-frame) and that it is the first/last packet of the PDU-set. Based on this information, the WTRU may be able to estimate the size of the PDU-set.

For example, in an encoding scheme where different types of frames are encoded into different traffic streams (e.g., GOP-based whereby a single video frame is either an I-frame or P-frame), the WTRU may receive indication linking the data flow to the frame type only once at the start of the session. In an example, the indication from the application to the WTRU may be bit-type, where “0” may correspond to a data flow with I-frames while “1” may corresponding to a data flow with P-frames.

For example, the WTRU may receive information about the size of the PDU-set on a PDU-set basis and/or on a per-flow basis (e.g., in the GOP-based encoding scheme). This exchange may happen at the start of the XR session. The WTRU may receive regular updates throughout the XR session periodically or only if there is a change in the information (e.g., change in size of PDU-set).

For example, the WTRU may receive information from the application/higher layers on multiple PDU-sets (i.e., granularity of group of PDU-sets). The application may group PDU-sets based on similarities between individual PDU-sets (e.g., same size, type, importance/priority, etc.).

For example, importance of data may be indicated to the WTRU from the application on different data-unit granularities, i.e., importance on a per-frame basis and/or per-PDU basis and/or per-PDU-set basis and/or per-group of PDU-sets basis, etc.

For example, indication of importance may be indicated for every data unit or it may be indicated for a first data unit and no indication is sent for the following data units until/unless there is a change in the importance. Indication of importance may be as simple as a bit-wise binary indication or a flag indicating if the data is important enough to necessitate a special treatment for example.

For example, indication of importance may be indicated through a table mapping different QoS levels in the legacy QoS framework to different important levels. In an example, the four most important QoS levels from the QoS framework may be flagged as important such that the WTRU may determine that any data mapped to radio bearers with the corresponding QoS flows from the four most important QoS levels may need to be sent before transitioning to another cell/gNB. Any data mapped to radio bearers with QoS flows from the remaining QoS levels may wait until after HO is completed to be transmitted.

For example, indication of importance may override QoS levels from the traditional QoS framework in some cases (e.g., if the data in the buffer is about to expire).

The configuration information that may be received by the WTRU from the network may include a combination of one or more of the following (a-c):
a) Mapping/forwarding/resource configurations and/or parameters (a1-a3):
a1) For example, the WTRU may receive one or more configurations and/or sets of configuration parameters to be applied at different layers of the protocol stack (e.g., SDAP, PDCP, RLC, MAC, PHY or any new layer). The configurations parameters may include (a1a-a1e):
a1a) SDAP: 1-to-1, 1-to-M or N-to-M mapping configurations, markings/indications/IDs to apply (e.g., associated with QoS flows, PDU sets, data busts), association info indication association between PDUs, PDU sets and/or data bursts, range of values associated with importance/priority of PDUs, PDU sets and/or data bursts.
a1b) PDCP (a1b1-a1b7):
a1b1) rules/criteria for mapping PDUs, PDU sets, and/or data bursts to two or more RLC entities/LCHs/legs;
a1b2) rules/criteria for assigning sequence numbers (e.g., COUNT range, Hyper Frame Number (HFN) range, and SN range) for PDUs, PDU sets and/or data bursts;
a1b3) RoHC configuration to apply to legs associated with source and/or target;
a1b4) security/encryption parameters to apply to legs associated with source and/or target;
a1b5) indication/flag on whether to apply any packet duplication;
a1b6) rules/criteria for discarding PDU sets, and/or data bursts (e.g., discard timers);
a1b7) rules/criteria for ensuring in-order delivery of PDUs, PDU sets and/or data bursts.
a1c) RLC: mode (AM/UM/TM) and parameters to apply to the legs associated with source and/or target
a1d) MAC: rules/criteria to apply to the LCHs/MAC entities in the legs associated with source and/or target including (a1d1-a1d3):
a1d1) LCH parameters (e.g., priority, PBR, BSD);
a1d2) LCP (e.g., rules/restrictions for handling PDU sets and/or data bursts, time duration for changing between different LCP rules);
a1d3) configurations for multiplexing PDU sets/data bursts to TBs.
a1e) PHY: HARQ configurations (e.g., number of allowed ReTx)
a2) For example, the WTRU may receive one or more resource configurations to be used before, during, or after HO, including (a2a-a2d):
a2a) Configured grant resources/configurations for UL data transmissions. The parameters associated with CG resources/configurations may include any of periodicity, start offset, duration, BWPs, numerology/SCS values, number of PRBs, number of occasions, number of PUSCH slots per occasion, maximum number/duration/length of PUSCH, one or more MSC values for the grant, antenna ports, etc., for example;
a2b) Semi-persistent scheduling (SPS) resources/configurations for DL data receptions. The parameters associated with SPS resources/configurations may include any of periodicity, start offset, duration, BWPs, numerology/SCS values, number of PRBs, number of occasions, number of PDSCH slots per occasion, maximum number/duration/length of PDSCH, one or more MCS values for the grant, antenna ports, etc., for example;
a2c) Dynamic grant resources for UL data transmission;
a2d) Dynamic scheduling resources for DL data receptions.
a3) The WTRU may receive at least one set of configuration parameters associated with default configuration, which may be activated and/or used during normal scenarios for transmitting/receiving data during HO, for example. The WTRU may also receive another set of configuration parameters which may be associated with exceptional operation, possibly activated and/or used when detecting any of the triggering events/conditions during HO, for example.
b) Validity information (b1-b2):
b1) For example, the WTRU may receive validity information associated with the forwarding/resource configurations, indicating whether/when the configurations are considered to be valid or invalid, based on one or more of triggering events/conditions;
b2) The WTRU may also receive information on whether the configurations are to be deactivated and/or released when determining them to be invalid.
c) Threshold values (c1-c4):
c1) Buffer occupancy threshold (c1a):
c1a) For example, the buffer occupancy threshold values associated with any of forwarding configurations may indicate the maximum/minimum amount of data units in one or more granularities/types including PDUs, PDU sets and data bursts (e.g., in terms of total payload size/volume) that may be included in the buffer (e.g., SDAP buffer, PDCP buffer, LCH buffer).
c2) PDU set payload size threshold values (c2a-c2b):
c2a) For example, the payload size threshold values may be associated with one or more upper and/or lower bound values corresponding to the total size of payload (e.g., in the units of bits or bytes) of one or more PDUs, PDU sets, and/or data bursts.
c2b) In another example, the payload size threshold values may be associated with one or more upper and/or lower bound values corresponding to the total number of PDUs in a PDU set or total number of PDU sets in a data burst.
c3) Delay threshold values (c3a-c3b):
c3a) Delay threshold values may be associated with one or more upper and/or lower bound values corresponding to maximum/minimum delay value associated with reception, buffering, and/or transmission of any of data units (e.g., PDUs, PDU sets, data bursts).
c3b) Such delay threshold values may be intended to identify and/or determine the maximum/minimum latency tolerated by the network, application, and/or WTRU, possibly as a result of delays due to HO, processing, jitter, transmission, congestion, etc., for example.
c4) Correlation time window (c4a-c4b):
c4a) For example, the correlation time window may correspond to the minimum time difference between two triggering events (e.g., reception of HO command message, transmission of HO complete message, buffer level measurements, PDU/PDU set arrival time), where the two events may be considered as correlated between one and another when they occur within the correlation time window.
c4b) When the two events occur at time instances beyond the correlation time window, they may be considered independent. In an example, the WTRU may use the correlation time window for determining whether to initiate RA with the target when triggered by DAPS HO command or whether to release connection with source.

### WTRU Actions

Throughout the discussion herein, WTRU actions, possibly related to application actions and/or AS-layer actions may correspond to any of: performing measurements and reporting, handling/forwarding of data/PDUs/PDU sets and handling QoS associated with PDUs/PDU sets, handling/forwarding of information related to connectivity with network and/or other WTRUs, and triggering HO and data transmission/reception during HO.

With regard to performing measurements and reporting, for example, the WTRU may perform measurements of pose (e.g., 6DoD/3DoD orientation, location/position), rate of motion/movement, etc. of the user/WTRU and/or other objects (e.g., virtual or real) that the user may be interacting with. The WTRU may send/report the pose measurements to the network periodically or when detecting event triggers (e.g., change in pose measurements above/below a threshold). For example, the WTRU may perform measurements of one or more of reference signals (e.g., SSB, CSI-SR, PRS, sidelink RS), GNSS signals, unlicensed carriers, ultra-wideband signals, LIDAR signals, visual signals, etc. In another example, the WTRU may perform measurements of the radio link interfaces associated with the WTRU (e.g., Uu link, SL). WTRU may trigger transmission and/or measurement of reference signals in other one or more WTRUs (e.g., via Uu link and/or sidelink), for example. The WTRU may send measurement report to network and/or another WTRU.

With regard to handling/forwarding of data/PDUs/PDU sets and handling QoS associated with PDUs/PDU sets, for example, data may include any of media/image/video frames, sensor data, and measurement data (e.g., pose measurements, link/channel measurements) determined by WTRU, possibly for supporting an application/service/network request associated with the WTRU. For example, the WTRU may send and/or receive data, to/from one more destinations including RAN node (e.g., gNB), CN function/entity, application function (e.g., hosted in WTRU or in network). For example, the WTRU may transmit and/or receive data, including user plane and/or control plane data, to/from the source or target, possibly when configured to perform DAPS handover and/or when configured with one or more DAPS radio bearers. In an example, such UL transmissions and/or DL receptions may be performed by the WTRU either via the source or the target, one at a time. In another example, such UL transmissions and/or DL receptions may be performed by WTRU via both the source and the target simultaneously. For example, the WTRU may perform splitting/merging of data/PDUs in one or more QoS flows into one or more forwarding configurations during transmission/reception.

With regard to handling/forwarding of information related to connectivity with the network and/or other WTRUs, this may include: sending capability information to network, including capability for supporting one or more interfaces, capability to coordinate and/or interact with other WTRUs/devices (e.g., via SL interfaces), which may be co-located or non co-located with the WTRU, for example, receiving configuration, including receiving RRC configuration from gNB and/or NAS-layer configuration from CN; sending and/or receiving assistance data to/from network associated with traffic, QoS, scheduling, etc., for supporting UL/DL transmissions; sending requests for radio resources and/or resource grants (e.g., dynamic grants, semi-static/configured grants).

With regard to triggering HO and data transmission/reception during HO, this may include: determining whether and when to trigger initial access with the target; transmitting or receiving initial access messages to target during HO execution; receiving RRC messages (e.g., HO command) from the source; transmitting RRC messages (e.g., RRC Reconfiguration Complete) to the target; determining whether to transmit any UL data (e.g., PDU sets, data bursts) to source and/or target; and determining whether and when to release connection with source.

### Aspects Related to Mapping of PDU Sets and Bearers, Logical Channels, Etc.

A PDU-set may consist of one or more PDUs.

A PDU-set may consist of PDUs corresponding to only one type of frame (e.g., I-frame) or PDUs corresponding to different types of frames (I-frames, P-frames, B-frames, etc.).

The size of the PDU-set may be variable from one PDU-set to another.

PSDB (PDU set delay budget) is the time from the reception of the first PDU of a PDU set at the WTRU (e.g., from application layer), until the last packet of the PDU set is received at the network (e.g., base station or UPF) and/or at the application server.

TTL (time to live) or remaining delay/PSDB for a PDU set is considered to be equal to PSDB minus the total time elapsed since the first PDU of the PDU set arrived at the WTRU's transmission buffer.

In some cases, the PDUs within a given PDU set can have different characteristics (e.g., type, importance), and it may be desirable to determine the path for the PDUs of the PDU set based on a combination of the characteristics of the PDUs within the PDU set (e.g., type, importance, etc.). In order to enable this, it may be required that the WTRU is able to determine or estimate the characteristics of the different PDUs within the PDU set at the start of the first PDU of the PDU set (e.g., based on information from the application layer, based on information on the headers of the first or first few PDUs at the start of the first PDU set, etc.).

A data burst is likely to contain PDU sets of different characteristics (e.g., different types, size, importance levels, PSDBs, etc.), and it may be desirable to determine the path for the data burst based on the combination of the characteristics of the PDU sets. In order to enable this, it may be required for the WTRU to be able to determine or estimate the characteristics of the different PDU sets within the data burst at the start of the first PDU set within the data burst (e.g., based on information from the application layer, based on information on the headers of the first or first few PDUs at the start of the first PDU set, etc.) The WTRU performs mapping of the data units (e.g., PDUs, PDU sets, data bursts), received from upper layers/application in one or more QoS flows (e.g., QFIs) to certain forwarding configurations comprising of a combination of different DRBs and/or LCHs, during UL transmission.

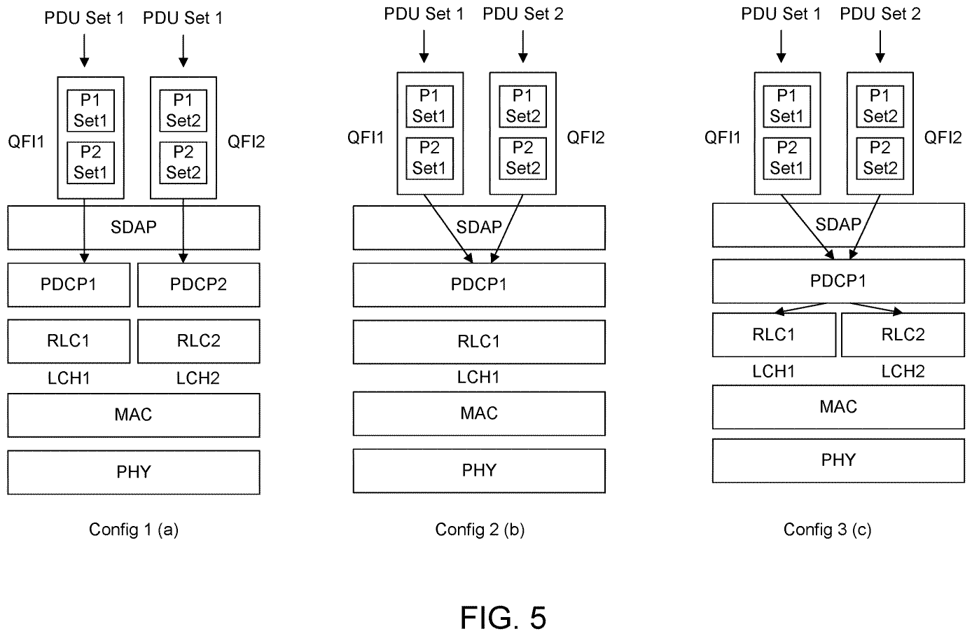

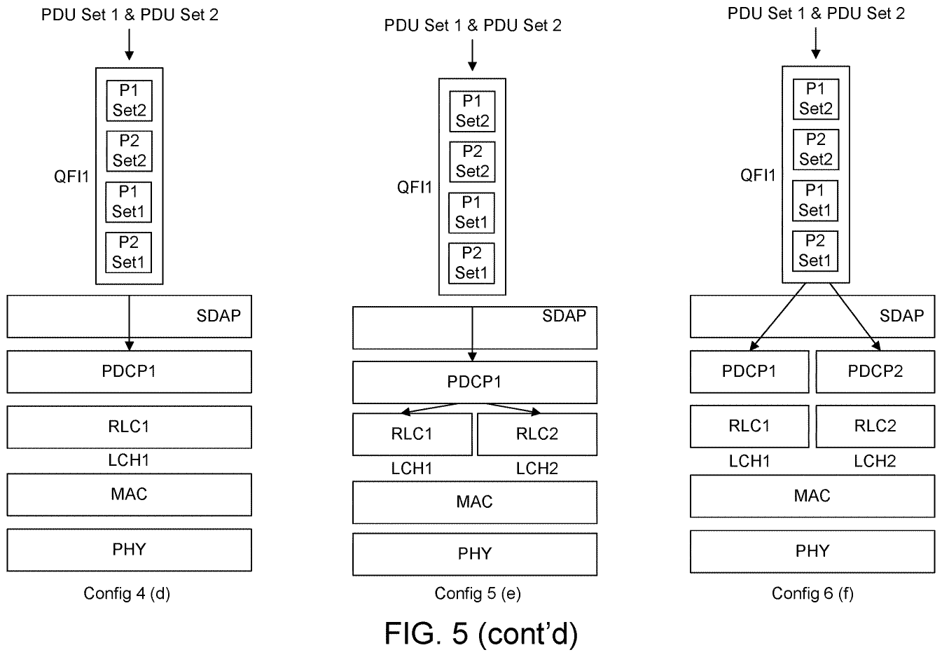

In one example related to configuration 1, which is illustrated in example (a) of FIG. 5, the WTRU may receive one or more PDUs associated with PDU set 1 and PDU set 2 in QFI1 and QFI2, respectively. The received PDU sets may be mapped to DRB1 (e.g., PDCP1) and DRB2 (e.g., PDCP2) at the SDAP sublayer/entity. Each PDCP entity (e.g., PDCP1 and PCDP2) may be configured to support in-order delivery of PDUs in PDU set 1 and PDU set 2, respectively. The PDUs of PDU set 1 and PDU set 2 may be mapped to LCH1 and LCH2, possibly corresponding to RLC1 and RLC2, respectively. The MAC entity/sublayer may ensure the QoS of the PDU sets (e.g., PSDB) in the respective LCHs may be met, possibly based on the PDU set parameters (e.g., priority) and/or using LCP procedure, during scheduling and/or multiplexing of the PDU sets into one or more TBs for UL transmission, for example.

In one example related to configuration 2 illustrated in example (b) of FIG. 5, the WTRU may receive one or more PDUs associated with PDU set 1 and PDU set 2 in QFI1 and QFI2, respectively. The received PDU sets may be multiplexed/mapped to DRB1 (e.g., PDCP1) at the SDAP sublayer/entity. The PDUs of PDU set 1 and PDU set 2 may be mapped to LCH1, possibly corresponding to RLC1. The MAC entity/sublayer may ensure the QoS of the PDU sets (e.g., PSDB) in LCH1 may be met, possibly based on the PDU set parameters (e.g., priority, SNs) and/or using LCP procedure, during scheduling and/or multiplexing of the PDU sets into one or more TBs for UL transmission, for example.

In one example related to configuration 3 illustrated in example (c) of FIG. 5, the WTRU may receive one or more PDUs associated with PDU set 1 and PDU set 2 in QFI1 and QFI2, respectively. The received PDU sets may be mapped to DRB1 (e.g., PDCP1) at the SDAP sublayer/entity. The PDUs of PDU set 1 and PDU set 2 may be mapped to LCH1 and LCH2, possibly corresponding to RLC1 and RLC2, respectively. The MAC entity/sublayer may ensure the QoS of the PDU sets (e.g., PSDB) in the respective LCHs may be met, possibly based on the PDU set parameters (e.g., priority) and/or using LCP procedure, during scheduling and/or multiplexing of the PDU sets into one or more TBs for UL transmission, for example.

In another example related to configuration 4 illustrated in example (d) of FIG. 5, the WTRU may receive one or more PDUs associated with PDU set 1 and PDU set 2 in QFI1. The received PDU sets may be mapped to DRB1 (e.g., PDCP1) at the SDAP sublayer/entity. The PDUs of PDU set 1 and PDU set 2 may be mapped to LCH1, possibly corresponding to RLC1. The MAC entity/sublayer may ensure the QoS of the PDU sets (e.g., PSDB) in LCH1 may be met, possibly based on the PDU set parameters (e.g., priority) and/or using LCP procedure, during scheduling and/or multiplexing of the PDU sets into one or more TBs for UL transmission, for example.

In another example related to configuration 5 illustrated in example (e) of FIG. 5, the WTRU may receive one or more PDUs associated with PDU set 1 and PDU set 2 in QFI1. The received PDU sets may be mapped to DRB1 (e.g., PDCP1) at the SDAP sublayer/entity. The PDUs of PDU set 1 and PDU set 2 may be mapped to LCH1 and LCH2, possibly corresponding to RLC1 and RLC2 respectively. The MAC entity/sublayer may ensure the QoS of the PDU sets (e.g., PSDB) in the respective LCHs may be met, possibly based on the PDU set parameters (e.g., priority) and/or using LCP procedure, during scheduling and/or multiplexing of the PDU sets into one or more TBs for UL transmission, for example.

In one example related to configuration 6 illustrated in example (f) of FIG. 5, the WTRU may receive one or more PDUs associated with PDU set 1 and PDU set 2 in QFI1. The received PDU sets may be mapped to DRB1 (e.g., PDCP1) and DRB2 (e.g., PDCP2) at the SDAP sublayer/entity. Each PDCP entity (e.g., PDCP1 and PCDP2) may be configured support in-order delivery of PDUs in PDU set 1 and PDU set 2, respectively. The PDUs of PDU set 1 and PDU set 2 may be mapped to LCH1 and LCH2, possibly corresponding to RLC1 and RLC2 respectively. The MAC entity/sublayer may ensure the QoS of the PDU sets (e.g., PSDB) in the respective LCHs may be met, possibly based on the PDU set parameters (e.g., priority) and/or using LCP procedure, during scheduling and/or multiplexing of the PDU sets into one or more TBs for UL transmission, for example.

The WTRU may be configured with a behavior that is dependent on the active bearer/application type. For example, the WTRU may be configured to apply any of the proposed embodiments/behaviors below if there is an active VR application, but apply legacy behavior otherwise. As another example, the WTRU may be configured to apply the new behavior/embodiment if there is any active XR traffic (e.g., AR, VR, MR, etc.). In another example, the WTRU may be configured to consider only the PDU sets or data bursts belonging to a certain bearer(s)/LCH(s) or application type(s) (e.g., AR, VR, MR, etc.).

The embodiments below mainly deal with CHO/DAPS/HO related behavior that is dependent on UL traffic. However, all the solutions are also equally applicable to DL traffic. In order to enable this, the WTRU may need to be configured to become aware of the behavior of DL traffic (e.g., PSDBs or TTLs of ongoing PDUs, total/pending data size of PDU sets, priority of DL PDU sets, importance level of PDU sets or PDUs, DL buffer size at the network, etc.). The WTRU may be configured with this information explicitly from the network or it can gather the information implicitly (e.g., based on header information on the PDUs, based on earlier behavior of PDU set, e.g., how big the PDU sets were in previous instances, etc.).

Where conditions related to both DL and UL traffic is to be considered, the WTRU may be configured to take into account the UL and DL PDU sets all together according to any of the embodiments below or it may be configured to prioritize the UL or DL PDU sets in determining the action to be taken.

Further restrictions on the application/bearer type, or importance type, etc., mentioned above may be taken on both UL and DL PDU sets in the same way or only on the UL PDU sets or only on the DL PDU sets.

The embodiment descriptions below mainly focused on enhancements related to XR applications/bearers. However, all the solutions are equally applicable to any kind of service/application where there is interdependence between PDUs, where PDUs of a given bearer may be of different types/importance, where a burst of inter-related PDUs may arrive in bursty or semi periodic manner, etc. As such, the behaviors discussed herein that are described in terms of PDU sets, data bursts, frames, etc., can easily be mapped to the behavior of such types of services/applications/traffic.

### HO Execution That Considers Ongoing PDU Sets or Data Bursts

In accordance with embodiments, a WTRU may defer/delay the execution of a HO (e.g., CHO, DAPS HO, legacy HO, etc. ,) until certain conditions related to ongoing PDU sets or data bursts are further fulfilled.

In this first embodiment, a WTRU may perform the following actions.

Upon being instructed to perform a HO (e.g., legacy HO, DAPS HO) or the fulfillment of the triggering conditions of a CHO, the WTRU defers the execution of the HO until one or more of the following are fulfilled: the pending PDUs of ongoing PDU sets or data bursts has been received or transmitted via the source (all ongoing PDU sets/data bursts or PDU sets/data bursts with certain characteristics); the radio conditions towards the source are below a certain configured threshold; a certain configured time duration has elapsed.

The WTRU sends information to the network about the delayed execution of the HO, including the cause for the delay (e.g., in the complete message to the target, in a (new) message towards the source, etc.).

In the following discussion, embodiments are described wherein the WTRU delays the execution of a HO (e.g., executing a CHO command upon the fulfillment of the triggering conditions or not starting the RA to the target in the case of DAPS HO, etc.) depending on the ongoing PDU sets and their characteristics.

It should be noted that all of the embodiments discussed below are equally applicable to the triggering of measurement reports for mobility (e.g., the triggering of measurement reports according to certain radio conditions of source or/and target are delayed based on the ongoing PDU sets and their characteristics).

### WTRU Configured to Consider the Size/Number/Percentage of PDUS Within a PDU Set or a Data Burst

In one exemplary embodiment, if the WTRU is in the middle of transmitting/receiving packets belonging to a certain PDU set when the CHO conditions are fulfilled or a DAPS HO command is received, the WTRU may wait until those pending PDUs of the PDU set are transmitted/received before executing the HO and/or initiating the RA and switching to the target cell. The actions associated with switching to the target may include any of initiating the RA to the target (e.g., transmission of Msg1 during 4 step RACH or MsgA during 2 step RACH, reception of Msg2 during 4 step RACH or MsgB during 4 step RACH, etc. ,) and transmitting RRC Reconfiguration Complete message to target, for example.

In one exemplary embodiment, if the WTRU is in the middle of transmitting PDUs belonging to a certain data burst when the CHO conditions are fulfilled or a HO command (E.g., DAPS HO) is received, the WTRU may wait until those pending PDUs of the data burst are transmitted via the source before switching to the target.

In one exemplary embodiment, the determination may be based on the size of the PDU set currently being transmitted. For example, if the PDU set in question is a large frame (e.g., above a certain threshold values), the WTRU may determine that, by the time the PDU set is fully transmitted/received, the CHO conditions may no longer be fulfilled or the source radio conditions may become unacceptably poor. As such, the WTRU may switch to the target immediately (i.e., perform the CHO, start RA toward the target cell, etc.). On the other hand, if the PDU set in question is a smaller-sized frame (e.g., a differential frame), the WTRU may decide to wait until the entire PDU set is transmitted before switching to the target.

In one exemplary embodiment, the WTRU may wait until the pending PDUs of the PDU set and/or the data burst are transmitted before switching to the target only if the remaining number of PDUs to be transmitted is below a certain configured threshold (e.g., in number of PDUs, in size of the PDUs, e.g., Kbytes of the remaining PDUs, percentage of the remaining PDUs of the PDU set or the data burst, percentage size of the remaining PDUs, e.g., percentage of the Kbytes of the remaining PDUs as compared to the total Kbytes of the PDU set or the data burst, etc.).

In one exemplary embodiment, the WTRU may wait until a certain number of (or percentage of) the PDUs of a PDU set or data burst are transmitted via the source before initiating the RA towards the target.

In one exemplary embodiment, the WTRU may wait until a certain number of (or percentage of) the PDUs of a PDU set or data burst remain to be transmitted before switching to the target.

In one variant of the above exemplary embodiments, the WTRU may wait until the pending PDUs of the PDU set and/or data burst are transmitted only if the QoS (e.g., PSER, PSDB) associated with the PDU set or remaining PDUs of the PDU set or data burst is above or below one or more threshold values.

### WTRU Configured to Consider the Type of PDU Sets or Data Bursts

In one exemplary embodiment, if the WTRU is in the middle of transmitting/receiving packets belonging to a certain PDU set when the CHO conditions are fulfilled or a DAPS HO command is received, the WTRU may be configured to delay or not delay the switching to the target until the pending PDUs are transmitted/received based on the type of the PDU set currently being transmitted. For example, if the PDU set in question is a large frame (e.g., I frame), the WTRU may determine that, by the time the PDU set is fully transmitted/received, the CHO conditions may no longer be fulfilled or the radio conditions towards the source may become unacceptably poor. As such, the WTRU may trigger the switching to the target immediately. On the other hand, if the PDU set in question is a smaller frame (e.g., a differential frame like P-frame or B-frame), the WTRU may decide to wait until all the PDUs in the PDU set are transmitted before switching to the target.

### WTRU Configured to Consider the Periodicity of the PDU Sets or Data Bursts

In one exemplary embodiment, the WTRU may wait until the pending PDUs of the PDU set and/or pending PDU sets of a data burst/QoS flow are transmitted before executing CHO or switching to the target after receiving a DAPS HO command only if the periodicity associated with the ongoing XR traffic (e.g., PDU set or data burst) is above or below one or more threshold values. The periodicity, in this case, may refer to the duration between two periodic occasions or the time remaining for the expected transmission of a second set of one or more PDUs/PDU sets upon transmission of a first set of one or more PDUs/PDU sets. In a scenario, the periodicity of UL XR traffic may be variable over one or more occasions in the presence of jitter (e.g., due to processing delays). In an example associated with periodic UL XR traffic, if the periodicity is less than or equal to a threshold value, the WTRU may delay executing the switching to the target by transmitting any remaining PDUs/PDU sets via the source. Alternatively, if the periodicity is greater than a threshold, the WTRU may immediately switch to the target when the CHO conditions are fulfilled or when a DAPS HO command is received.

In an example associated with periodic UL XR traffic, if the periodicity (e.g., time duration between two periodic occasions) is less than or equal to a threshold value associated with the duration for establishing connection with the target (e.g., initiate RA, transmit RRC Reconfig Complete message), the WTRU may delay initiating RACH with the target, and transmit any remaining PDUs via the source. Alternatively, if the periodicity is greater than the duration for establishing connectivity with the target, the WTRU may immediately initiate RA after receiving the DAPS HO Command or the fulfillment of the CHO conditions, and transmit the remaining PDUs via the target.

### WTRU Configured to Consider the Importance of the PDUs or PDU Sets

In one exemplary embodiment, if the WTRU is in the middle of transmitting/receiving packets belonging to a certain PDU set when the CHO conditions are fulfilled or a DAPS HO command is received, the WTRU may or may not determine to delay the switching to the target until the pending PDUs are transmitted/received based on the importance of the PDU sets currently being transmitted. In an example, the WTRU may wait until the pending PDUs of the PDU set and/or data burst are transmitted only if the importance/priority associated with the ongoing PDU set or remaining PDUs of the PDU set is above or below one or more threshold values. For example, if the PDUs within a PDU set have importance levels 1 to 3, wherein 1 is the highest priority and 3 is the lowest, the WTRU may be configured to consider only the PDUs with an important level of 1 (or level 1 and 2) when applying any of the above embodiments. In another example, if the importance of an ongoing PDU set is higher than a threshold value, the WTRU may wait until all pending PDUs of the PDU set are transmitted before switching to the target.

### WTRU Configured to Consider the PSDB/TTL of the PDU Sets or Data Bursts

In one exemplary embodiment, if the WTRU is in the middle of transmitting/receiving packets belonging to a certain PDU set when the CHO conditions are fulfilled or a DAPS HO command is received, the WTRU may be configured to delay or not delay the switching to the target until the pending PDUs are transmitted/received based on the PSDB of the PDU sets currently being transmitted. In an example, the WTRU may wait until the pending PDUs of the PDU set and/or data burst are transmitted before switching to the target if the PSDB of the ongoing PDU set is below a certain threshold value.

In variant of the exemplary embodiments above, instead of the PSDB, the time to live (TTL) or remaining delay for the PDU set may be considered. For example, the WTRU may be configured to delay the switching to the target if there are pending PDUs of a PDU set that have a TTL below a configured threshold.

In one exemplary embodiment, the WTRU may be configured to consider the time to live (TTL) or remaining delay for the PDU set (i.e., time remaining before the PSDB is exceeded) instead of or in addition to the PSDB. For example, if the TTL of the ongoing PSDB is below a certain configured threshold (e.g., x milliseconds, % of the PSDB, etc.), the WTRU may wait until those pending PDUs of the PDU set are transmitted via the source or the PSDB of the PDU set is exceeded before initiating the RA to the target.

In one exemplary embodiment, if the WTRU is in the middle of transmitting packets belonging to a certain data burst when the CHO conditions are fulfilled or a DAPS HO command is received (e.g., certain PDUs or/and PDU sets of the data burst are already transmitted or being transmitted, while others are pending in the UL buffers), if the time to live (TTL) for the data burst is below a certain configured threshold (e.g., x milliseconds, % of the PSDB of the PDU set within the data burst with the longest PSDB, % of the PSDB of the PDU set within the data burst with the shortest PSDB, % of the average PSDB of the PDU sets within the data burst, etc.), the WTRU will wait until those pending PDUs or/and PDU sets are transmitted via the source or the PSDB of one or more of the PDU sets within the data burst is exceeded before initiating the RA to the target.

### WTRU Configured to Delay the Switching to the Target for a Certain Duration

In one exemplary embodiment, the WTRU may be configured to switch to the target after CHO conditions are fulfilled or after the reception of a DAPS HO command within a time window.

In one example, the WTRU may be configured with a maximum time duration that it can delay the switching to the target, no matter what the conditions of the ongoing PDU sets or data bursts are (e.g., even if there are pending PDUs of high importance the WTRU was configured to transmit before switching to the target).

In one example, the WTRU may wait until the configured time duration has elapsed even if the WTRU has managed to transmit all the ongoing PDUs of certain characteristics that the WTRU was configured to transmit before switching to the target.

In one example, the WTRU may switch to the target before the configured waiting time duration has elapsed if it determines that it has managed to transmit all the ongoing PDUs of certain characteristics that the WTRU was configured to transmit before switching to the target.

In one example, the WTRU may be configured with different thresholds, S1, S2, S3, etc., corresponding to different sizes of complete/partial PDU sets. Partial PDU set throughout this disclosure refers to the remaining PDUs of the PDU set that have not yet been transmitted/received at the source and/or target gNB. For example, if the size of the PDU set/partial PDU set to be transmitted<S1, the WTRU may be configured to apply a (maximum) delay of t1 before switching to the target. If the size of the PDU set/partial PDU set to be transmitted larger than S1 but smaller than S2, the WTRU may be configured to apply a (maximum) delay of t2 before switching to the target, etc.

In one example, the WTRU may be configured with different thresholds, SI, SP, SB, etc. corresponding to different types of PDU sets/frames. For example, if the type of the PDU set/partial PDU set to be transmitted=SI, the WTRU may be configured to apply a (maximum) delay of t1 before switching to the target. If the type of the PDU set/partial PDU set to be transmitted is=SP or SB, the WTRU may be configured to apply a (maximum) delay of t2 before switching to the target, etc., In this example, t1 may be configured to be larger than t2, since I-frames are generally larger than P-frames or B-frames.

### WTRU Configured to Consider Total UL Buffer Levels

In one exemplary embodiment, the WTRU may delay the switching to the target (e.g., for a certain duration, until the conditions below get fulfilled, etc. ,) after the CHO conditions are fulfilled or a DAPS HO command is received, if one or more of the following conditions are not fulfilled: the UL buffer of a certain bearer or LCH (e.g., bearer belonging to an XR application) is above a certain configured threshold; the UL buffer of a certain bearer or LCH (e.g., bearer belonging to an XR application) is below a certain configured threshold; the UL buffer of a sub-set of bearers or LCHs (e.g., specific list of bearers, all bearers belonging to XR applications, all bearers belong to a certain type of XR applications, e.g., VR, etc. ,) is above a certain configured threshold; the UL buffer of a sub-set of bearers or LCHs (e.g., specific list of bearers, all bearers belonging to XR applications, all bearers belong to a certain type of XR applications, e.g., VR, etc. ,) is below a certain configured threshold; the total UL buffer level is above a certain configured threshold (e.g., UL buffer is above a certain absolute or percentage threshold, available UL buffer is below a certain absolute or percentage threshold, etc.); the total UL buffer level is below a certain configured threshold (e.g., UL buffer is below a certain absolute or percentage threshold, available UL buffer is above a certain absolute or percentage threshold, etc.).

### T304 Aspects

In NR, the WTRU starts timer t304 upon the reception of a HO command (i.e., RRC reconfiguration message that contains reconfiguration with sync, whether the HO is DAPS HO or legacy NR HO) and stops it when the RA with the target is complete. If the timer expires before the RA is completed successfully, the WTRU declares RLF/HOF (Radio Link Failure/Handover Failure) and initiates re-establishment. Thus, care must be taken to ensure that unnecessary re-establishments are triggered while the WTRU is trying to optimize the operation for XR traffic according to any of the solutions above.

In one solution, the WTRU does not start the timer t304 (or any other timer that is associated with the start and the completion of the HO process) until it has finalized the sending of the pending PDUs of a PDU set or/and data burst according to any of the embodiments above.

In one embodiment, the WTRU is provided with different timer t304 values to apply that are dependent on XR related traffic.

In one example, the WTRU is provided with a t304 value that is associated with a certain bearer/LCH (or bearers/LCHs), and if the WTRU has pending PDUs of a given PDU set or data burst belonging to this bearer or bearers when the HO command is received, it will use this timer value.

In another example, the WTRU is provided with scaling factors to apply on the WTRU's t304 value (e.g., scaling the timer value by a certain factor that depends on several factors such as the existence of pending PDUs of a PDU set or data burst belong to XR traffic, the amount of such pending data, the TTL/remaining delay of the PDU set or data burst, importance/priority of PDU set, etc.).

In yet another example, the WTRU is provided with one or more t304 values that may be associated with the different QoS (e.g., PSDB, PSER), importance/priority values, or types of the PDU sets. For example, when transmitting a type 1 PDU set (e.g., all PDUs of a PDU set are required by the application), the WTRU may use a t304 value with a longer duration compared to a type 2 PDU set (e.g., some lost PDUs of this PDU type within a PDU set may be tolerated by application).

If there are several bearers/LCHs associated with XR traffic, the WTRU may use a t304 timer value that is a function of all the t304 values determined according to each bearer/LCH according to any of the examples above. For example, the WTRU may choose the minimum, maximum, average, median, etc., of all the determined t304 values as the t304 value for the HO.

### WTRU Configured to Consider Radio Conditions of the Source Cell

Though it is desirable to finish the transmission of pending PDUs of a PDU set or a data burst with the source before initiating the RA to the target, care should be taken to ensure that the WTRU will not lose the connection to the source (whereupon the WTRU declares RLF/HOF and triggers re-establishment).

In one embodiment, the WTRU may be configured with a radio signal level threshold, and, if the signal level of the source falls below this threshold, the WTRU will switch to the target (even if there are still some pending PDUs of certain characteristics that the WTRU was configured to transmit) before switching to the target according to any of the embodiments above. This ensures that radio link failure will not occur while the WTRU is trying to optimize operation for the XR traffic.

### WTRU Actions on Executing the CHO

In one embodiment, after a certain delay due to waiting for the transmission of pending PDUs based on any of the embodiments above (or/and expiration of configured wait time/window), the WTRU may perform one of the following: execute the CHO immediately without checking if the CHO conditions are still fulfilled; execute the CHO only if the CHO conditions are still fulfilled (one time check); execute the CHO only if the CHO conditions are fulfilled for a certain duration (e.g., for a duration of TTT configured for the CHO event, for a different configured duration to be applied for this case, where this could be an absolute duration, e.g., ms, or a value that is associated with the TTT of the event, e.g., 30% of the TTT of the event, etc.).

### WTRU Triggers an Indication to NW Based on Fulfilment of CHO Criteria

In one embodiment, the WTRU may transmit an indication to the source, possibly on ongoing or expected UL XR traffic transmissions, based on fulfilment of a criteria associated with CHO. Such criteria may include triggering the indication within certain amount of TTT (e.g., within half of TTT) when a CHO condition is fulfilled (e.g., a measurement event is triggered), for example. The WTRU may transmit the indication, possibly for transmitting any pending PDUs/PDU, before executing CHO, for example.

### Combination of Solutions and Other Aspects

A combination of any or all the above embodiments is possible. For example, the WTRU may be configured to delay the execution of the CHO for PDU sets that have a certain importance level, type, remaining size less than one threshold, and/or TTL less than another threshold, etc.

The embodiments above could consider all the ongoing PDU sets that match the condition(s)/characteristic(s) that are associated with delaying the execution of the CHO, or the WTRU may be configured to consider only a certain number/percentage of the PDU sets (e.g., as there could be several ongoing PDU sets at the time of the fulfillment of the CHO triggering conditions, and the WTRU trying to flush all these remaining PDU sets before executing the CHO could require a lot of time and increases the chances of radio link failure).

The embodiments discussed above for delaying the execution of the CHO may be common to all CHO events/targets. For example, legacy CHO may be configured for several targets, and a common configuration may be used to specify how the CHO is to be delayed based on the status of ongoing PDU sets or data bursts according.

In other embodiments, the configuration may be specific to each CHO event and/or target.

In one embodiment, the WTRU may be configured to apply legacy behavior for some events (i.e., execute the CHO immediately upon the fulfillment of the conditions) while applying the above embodiments for other events (e.g., cond A3 event treated as in legacy, while cond A5 event affected by the above solutions).

In one embodiment, the WTRU may be configured to apply legacy behavior to the execution of the CHO toward some targets (i.e., execute the CHO immediately upon fulfillment of the conditions), while considering the above embodiments/behaviors based on the status of the ongoing PDUs sets.

In one embodiment, the WTRU may apply any of the behaviors specified above on PDUs belonging to some PDU sets, while applying legacy behavior on PDUs belonging to other PDU sets. For example, the WTRU may send the PDUs from some PDU set via the source and keep buffering the PDUs from another PDU set and send them only once the UL switching to the target is performed.

The above embodiments mainly dealt with DAPS HO. However, all the solutions are also equally applicable to legacy/normal handovers or other variants (e.g., CHO).

For example, the WTRU upon receiving a legacy HO command, may not receive any more DL data via the source, but may keep sending the UL data toward the source (e.g., for PDUs of a certain PDU set according to any of the embodiments above). Then, when the conditions for sending the UL to the source are no longer fulfilled, it may perform the RA to the target. It may additionally send an indication to the source (or alternatively to the target, which may forward it to the source) upon switching the transmission of the concerned PDUs via the target. For example, the WTRU may send indication to the gNB proactively on an upcoming UL data transmission to assist with HO (e.g., DAPS, CHO).

In one embodiment, the WTRU may be configured (e.g., in the DAPS HO command) for exactly how long the WTRU should wait before switching to using the target.

### CHO Triggering That Considers Ongoing PDU Sets or Data Bursts

In accordance with embodiments, a WTRU that is configured with a conditional handover reconfiguration may modify the CHO triggering conditions based on certain conditions related to ongoing PDU sets or data bursts are further fulfilled.

In this second embodiment, a WTRU may perform the following actions.

The WTRU receives a conditional reconfiguration containing radio related triggering conditions (e.g., target>source+threshold) and conditional reconfigurations to apply to handover from the source to a target when the triggering conditions are fulfilled.

Next, the WTRU is further configured to modify the triggering conditions (e.g., the absolute/relative threshold for the source/target links in the event configuration, the time to trigger, etc.) depending on one or more of the following: the pending PDUs of ongoing PDU sets or data bursts (e.g., number of ongoing PDU sets, size of remaining PDUs of PDU sets, etc.). In some embodiments, all PDU sets or data bursts may be considered. In other embodiments only certain PDU sets or data bursts are considered (e.g., PDU sets of certain type or importance, PDU sets with PSDB below a certain threshold, PDU sets with TTL below a certain threshold, PDU sets that have only a certain percentage/number of PDUs pending, etc.).

Finally, the WTRU sends information to the network about the updated CHO triggering conditions, execution of the reconfiguration, and the cause for the delay (e.g., in the complete message to the target, in a (new) message towards the source, etc.).

In the following discussion, embodiments are provided wherein the WTRU modifies the triggering conditions of a CHO depending on the ongoing PDU sets and their characteristics.

It should be noted that all of the embodiments below are equally applicable to the triggering of measurement reports for mobility (e.g., the triggering conditions of measurement reports according to certain radio conditions of source or/and target are modified based on the ongoing PDU sets and their characteristics).

### CHO Triggering Radio Thresholds That Depend on the PSDB of Ongoing PDU Sets or Data Bursts

In one embodiment, the WTRU may be configured with multiple CHO triggering thresholds that are dependent on the PSDB of ongoing PDU sets or data bursts. For example, the CHO triggering threshold could be configured as follows: threshold 1, if there is no ongoing PDU set; threshold 2, if there are some ongoing PDU set(s) and the smallest PSDB among the ongoing PDU sets is a ms; threshold 3, if there are some ongoing PDU set(s) and the smallest PSDB among the ongoing PDU set is b ms (b <a); threshold 4, if there are some ongoing PDU set(s) and the smallest PSDB among the ongoing PDU sets is c ms (c<b); etc.

In a variant of the embodiment above, instead of the PSDB, the time to live (TTL) or remaining delay for the PDU set (i.e., time remaining before the PSDB is exceeded) may be considered. For example, the CHO triggering threshold could be configured as follows: threshold 1, if there is no ongoing PDU set; threshold 2, if there are some ongoing PDU set(s) and the smallest TTL among the ongoing PDU sets is a ms; threshold 3, if there are some ongoing PDU set(s) and the smallest TTL among the ongoing PDU sets is b ms (b<a); threshold 4, if there are some ongoing PDU set(s) and the smallest TTL among the ongoing PDU sets is c ms (c<b); etc.

Alternatively to the above embodiments where different CHO triggering thresholds are associated with different PSDB or TTL values, a scaling factor may be configured where the WTRU is configured with one triggering threshold (i.e., as in legacy CHO), but it will scale the threshold depending on the PSDB or TTL of the ongoing PDU sets or data bursts. For example, the WTRU may be configured to apply no scaling (equivalent to applying a scaling factor of 1) if there is no ongoing PDU set with PSDB or TTL less than value1, use a scaling factor of f1 if there is no ongoing PDU set with PSDB or TTL less than value2 (value 2<value 1), etc.

In one example of the above embodiments, threshold 1>threshold 2>threshold 3, etc., i.e., the smaller the PSDB or TTL, the lower the CHO threshold.

In another example of the above embodiments, threshold 1<threshold 2<threshold 3, etc., i.e., the smaller the PSDB or TTL, the higher the CHO threshold.

In another embodiment, the WTRU may consider, not only the existence of ongoing PDU sets or data burst with a PSDB or TTL that is less than a certain value, but also the number of such PDU sets. That is, the threshold to be used may be configured to be lower or higher based on the number of such PDU sets or the relative percentage of such PDU sets.

In another embodiment, instead of the minimum PSDB or TTL values, the CHO triggering thresholds may be configured to be associated with the mean of the PSDB or TTL of all the ongoing PDU sets. This could be a simple mean or a weighted mean (e.g., based on the importance level of the PDU sets, where a more important PDU set gets more weight during the averaging). Other filtering/averaging mechanisms also may be employed (e.g., more/less weight given to PDU sets that have more total or remaining data size, more/less weight given to PUD sets that have been ongoing for a longer time, etc.).

### CHO Triggering TTTS That Depend on the PSDB of Ongoing PDU Sets or Data Bursts

In one embodiment, the WTRU may be configured with multiple TTT values for the CHO triggering that are dependent on the PSDB of ongoing PDU sets or data bursts. For example, the TTT values for the CHO event could be configured as follows: ttt1, if there is no ongoing PDU set; ttt2, if there are some ongoing PDU set(s), and the smallest PSDB among the ongoing PDU sets is a ms; ttt3, if there are some ongoing PDU set(s), and the smallest PSDB among the ongoing PDU set is b ms (b<a); ttt4, if there are some ongoing PDU set(s), and the smallest PSDB among the ongoing PDU sets is c ms (c<b); etc.

In a variant of the embodiment above, instead of the PSDB, the time to live (TTL) or remaining delay for the PDU set (i.e., time remaining before the PSDB is exceeded) may be considered. For example, the TTT values for the CHO event could be configured as follows: ttt1, if there is no ongoing PDU set; ttt2, if there are some ongoing PDU set(s), and the smallest TTL among the ongoing PDU sets is a ms; ttt3, if there are some ongoing PDU set(s), and the smallest TTL among the ongoing PDU sets is b ms (b<a); ttt4, if there are some ongoing PDU set(s), and the smallest TTL among the ongoing PDU sets is c ms (c<b); etc.

Alternatively to the above embodiments where different TTT values are associated with different PSDB or TTL values, a scaling factor may be configured wherein the WTRU is configured with one baseline TTT threshold (i.e., as in legacy CHO), but will scale the TTT to be used depending on the PSDB or TTL of the ongoing PDU sets or data bursts. For example, the WTRU may be configured to apply no scaling (equivalent to applying a scaling factor of 1) if there is no ongoing PDU set with PSDB or TTL less than value1, use a scaling factor of f1 if there is no ongoing PDU set with PSDB or TTL less than value 2 (value 2 <value 1), etc.

In one example of the above embodiments, ttt 1>ttt 2>ttt 3, etc., i.e., the smaller the PSDB or TTL, the smaller the TTT to be used.

In one example of the above embodiments, ttt 1<ttt 2 <ttt 3, etc., i.e., the smaller the PSDB or TTL, the larger the TTT to be used.

In another embodiment, the WTRU considers, not only the existence of ongoing PDU sets or data burst with a PSDB or TTL that is less than a certain value, but also the number of such PDU sets. That is, the TTT to be used may be configured to be lower or higher based on the number of such PDU sets or the relative percentage of such PDU sets.

In another embodiment, instead of the minimum PSDB or TTL values, the TTT values may be configured to be associated with the mean of the PSDB or TTL of all the ongoing PDU sets. This could be a simple mean or a weighted mean (e.g., based on the importance level of the PDU sets, where a more important PDU set gets more weight during the averaging). Other filtering/averaging mechanisms may also be employed (e.g., more/less weight given to PDU sets that have more total or remaining data size, more/less weight given to PUD sets that have been ongoing for a longer time, etc.).

### CHO Triggering TTTS or Radio Thresholds That Depend on Buffer Size

In one embodiment, the WTRU may be configured with multiple TTT values or scaling factors of a baseline TTT value for the CHO event which depend on the current UL buffer size (e.g., used buffer size, remaining buffer size, etc.). For example, the WTRU may be configured with multiple TTT values, wherein higher TTT values are associated with lower used buffer size or vice versa.

In one embodiment, the importance level of the pending PDUs or PDU sets may be considered in the TTT determination by the WTRU. For example, the WTRU may be configured to apply TTT value 1 if the size of pending PDUs with importance level x is above threshold 1, apply TTT value 2 if the size of pending PDUs with importance level x is between threshold 1 and threshold 2, etc. Different TTT thresholds may be specified for different buffer sizes of different importance level, and the WTRU may choose to apply the longest or shortest TTT among those. For example, the WTRU may configured to apply TTT1 if there are more than x Kbytes of PDUs of importance level 1, and apply TTT2 if there are more than y Kbytes of PDUs of importance level 2, and, if both conditions are fulfilled, the WTRU may choose to consider the TTT to be equal to a function of TTT1 and TT2, wherein the function could be the minimum, maximum, average, etc. of TTT1 and TTT2.

In one embodiment, the PDU type of the pending PDUs or PDU sets may be considered in the TTT determination by the WTRU. For example, the WTRU may be configured to apply TTT value 1 if the size of pending PDUs of type a is above threshold 1, apply TTT value 2 if the size of pending PDUs of type a is between threshold 1 and threshold 2, etc. Different TTT thresholds may be specified for different buffer sizes of different PDU types, and the WTRU may choose to apply the longest or shortest TTT among those. For example, if the WTRU is configured to apply TTT1 if there are more than x Kbytes of PDUs of type a, and apply TTT2 if there are more than y Kbytes of PDUs of type b, and, if both conditions are fulfilled, the WTRU may choose to consider the TTT to be equal to a function of TTT1 and TT2, where the function could be the minimum, maximum, average, etc. of TTI1 and TTT2.

In one embodiment, the WTRU may be configured with multiple radio thresholds for triggering the CHO or scaling factor of a baseline threshold value that depends on the current UL buffer size (e.g., used buffer size, remaining buffer size, etc.). For example, the WTRU may be configured with multiple radio threshold values, wherein higher threshold values are associated with lower used buffer sizes or vice versa.

The WTRU may be configured to apply different radio thresholds based on the PDU type or importance level in a way similar to the embodiments above wherein different TTT values were associated with different buffers size of certain PDU type(s) or importance level(s).

### Consideration of Different CHO Events and CHO Targets

In one embodiment, the scaling-based solutions discussed above (e.g., scaling the TTT duration or/and radio thresholds up/down depending on the PSDB/TTL of ongoing PDU sets, either for all ongoing PDU sets or for PDU sets of a certain importance, type, pending buffer sizes, etc.) may be common to all CHO events/targets. For example, legacy CHO may be configured for several targets, each with a different baseline signal level threshold and TTT, and a common configuration may be used to specify how the scaling is to be for the signal threshold and/or TTT that is associated with all or a subset of the CHO targets. Alternatively, the legacy CHO configuration may be modified to contain the different scaling factors and related conditions.

In one embodiment, the configuration is specific to each CHO event and/or target.

In one embodiment, the WTRU may be configured to apply legacy behavior to the evaluation of the CHO triggering conditions of some events while applying the above embodiments for other events (e.g., cond A3 event treated as in legacy, while cond A5 event affected by the above solutions).

In one embodiment, the WTRU may be configured to apply legacy behavior to the evaluation of the CHO triggering conditions related to some targets, while considering the above embodiments/behaviors to adapt the triggering conditions based on the status of the ongoing PDUs sets.

### During DAPS HO, Using the Source UL for Ongoing PDU Sets, and Using the Target UL for New PDU Sets

In a third embodiment, a WTRU may be configured to send PDUs of new PDU sets or data bursts (i.e., PDU sets or data bursts that started after the reception of the DAPS HO command) via the target while it keeps sending the PDUs belonging to the old PDU sets or data bursts (i.e., PDU sets or data bursts that were ongoing when the DAPS HO command was received) via the source.

In the following discussion, embodiments are provided wherein the WTRU is configured to maintain two ULs during DAPS HO (i.e., one to the source and one to the target) until certain conditions related to the ongoing PDU sets or data bursts are fulfilled.

### WTRU Configured to Consider the Characteristics of the PDUs Within a PDU Set or a Data Burst

In one embodiment, if the WTRU is in the middle of transmitting/receiving packets belonging to a certain PDU set or data burst when the DAPS HO command is received, the WTRU may keep using the source link for the PDU set or data burst, and use the target link only for PDU sets or data bursts that arrive/start after the reception of the DAPS HO command or whose first PDU has not been transmitted yet over the source link.

In one embodiment, the determination may be based on the size of the PDU set or data burst currently being transmitted. For example, if the PDU set in question is a large frame (e.g., above a certain threshold values), the WTRU may start using the target link for the PDUs of the PDU set or data burst, as it might not be likely to finish transmitting all the concerned PDUs before the radio quality of the source link becomes unacceptably poor. On the other hand, if the PDU set in question is a smaller-sized frame (e.g., a differential frame), the WTRU may decide to keep using only the source link for the PDUs of the PDU set.

In one embodiment, the WTRU may determine to keep using only the source link for sending the pending PDUs of the PDU set or/and the data burst only if the remaining number of PDUs to be transmitted for the concerned PDU set or data burst is below a certain configured threshold (e.g., in number of PDUs, in size of the PDUs, e.g., Kbytes of the remaining PDUs, percentage of the remaining PDUs of the PDU set or the data burst, percentage size of the remaining PDUs, e.g., percentage of the Kbytes of the remaining PDUs as compared to the total Kbytes of the PDU set or the data burst, etc.).

In one variant of the above embodiments, the WTRU may decide to keep using only the source link for the pending PDUs of the PDU set and/or data burst only if the QoS (e.g., PSER, PSDB) associated with the PDU set or remaining PDUs of the PDU set or data burst remains above or below one or more threshold values.

In one embodiment, if the WTRU is in the middle of transmitting/receiving packets belonging to a certain PDU set or data burst when a DAPS HO command is received, the WTRU may be configured to determine to keep using the source link for the pending PDUs of the PDU set or data burst based on the type of the PDU set or data burst. For example, the WTRU may keep using the source link for pending PDU sets that are of type1, but switch to using the target link for pending PDU sets that are of type 2, etc.

In one embodiment, if the WTRU is in the middle of transmitting/receiving packets belonging to a certain PDU set or data burst when a DAPS HO command is received, the WTRU may be configured to keep using the source link for the pending PDUs of the PDU set or data burst based on the importance level of the PDU set or data burst. For example, the WTRU may keep using the source link for pending PDU sets that are of importance level 1, but switch to using the target link for pending PDU sets that are of importance level 2, etc.

In one embodiment, if the WTRU is in the middle of transmitting/receiving packets belonging to a certain PDU set when a DAPS HO command is received, the WTRU may be configured to keep using the source link for the pending PDUs of the PDU set or data burst based on the PSDB of the PDU set or data burst. In an example, the WTRU may be configured to keep using the source link for pending PDU sets that have PSDB below a certain threshold, but switch to using the target link for the PDU sets that have PSDB greater than or equal to the threshold, etc.

In a variant of the embodiment above, instead of the PSDB, the time to live (TTL) or remaining delay for the PDU set may be considered. For example, the WTRU may be configured to keep using the source link for pending PDU sets that have TTL below a certain threshold, but switch to using the target link for the PDU sets that have TTL greater than or equal to the threshold, etc.

### WTRU Configured to Keep Using the Source Link for Pending PDUs for a Certain Duration

In one embodiment, the WTRU may be configured with a maximum time duration during which it can keep using the source link for pending PDUs or PDU sets, no matter what the conditions of the ongoing PDU sets or data bursts are (e.g., even if there are pending PDUs of high importance for which the WTRU was configured to keep using the source link).

### WTRU Configured to Consider Radio Conditions of the Source Cell

In one embodiment, the WTRU may be configured with a radio signal level threshold, and the WTRU may keep using the source for some ongoing PDU sets or data bursts (according to any of the solutions above) only if the signal level of the source is above a configured threshold. Otherwise, the WTRU will switch to using the target even if there are still some pending PDUs of certain characteristics for which the WTRU was configured to keep using the source during DAPS HO.

### Other Aspects

A combination of any or all the above embodiments is possible. For example, the WTRU may be configured to keep using the source link for PDU sets that have an importance level, type, remaining size less than one threshold, TTL less than another threshold, until a certain time duration has elapsed, and until the radio conditions towards the source fall below a certain threshold, etc.

The embodiments above could consider all of the ongoing PDU sets that match the condition(s)/characteristic(s) that are associated with using the source link, or, alternately, the WTRU may be configured to consider only a certain number/percentage of the PDU sets (e.g., as there could be several ongoing PDU sets at the time of the reception of the DAPS HO command, and the WTRU trying to use only the source link to finish the transmission of all these remaining PDU sets could require a lot of time and increases the chances of radio link failure at the source link).

In one embodiment, the WTRU may keep using the source link for some of the PDU sets or data burst according to any of the embodiments above until the DAPS HO is complete (e.g., WTRU receives a message from the network to release the resources of the source).

In one embodiment, the WTRU may keep using the source link for some of the PDU sets or data burst according to any of the embodiments above until all the PDUs of the concerned PDU sets or data burst are transmitted, and may stop using the source link (for any transmission, for example) after that.

In one embodiment, the WTRU may be configured to send PDUs of new PDU sets or data bursts (i.e., PDU sets or data bursts that started after the reception of the DAPS HO command) via the target while sending the PDUs belonging to the old PDU sets or data bursts (i.e., PDU sets or data bursts that were ongoing when the DAPS HO command was received) via the source according to any of the embodiments above.

In another embodiment, the WTRU may apply the same behavior to the PDUs of the old and new PDU sets or data bursts (i.e., send the PDUs, whether the PDUs belong to the old or new PDU sets or data bursts, via the source first and then switch to the target according to any of the solutions above). In one variant of this embodiment, the switching conditions may be dependent only on the old PDU sets or data bursts (e.g., PDSB of the old PDU set, percentage/number of pending PDUs of a PDU set, etc.). In another variant of this embodiment, the switching conditions may be dependent on both the old and new PDU sets or data bursts (e.g., the switching of the old PDU sets is dependent on the PDSB of the old PDU set, and the switching of the new PDU set dependent on the PSDB of the new PDU set, etc.).

### WTRU Determining When to Release the Source Cell Resources During DAPS Ho

In accordance with embodiments, a WTRU that is configured with DAPS HO may decide to release the resources of the source based on certain conditions related to ongoing (UL/DL) PDU sets or data bursts are fulfilled.

In this fourth embodiment, a WTRU may perform the following actions.

The WTRU may receive a DAPS HO configuration (e.g., certain bearers configured for DAPS).

In response, the WTRU may release the source link (e.g., stop monitoring source PDCCH) when one or more of the following conditions are fulfilled: the pending PDUs of ongoing PDU sets or data bursts have been received or transmitted via the source (e.g., all ongoing PDU sets, PDU sets of certain type or importance, PDU sets with PSDB below a certain threshold, PDU sets with TTL below a certain threshold, PDU sets that have only a certain percentage/number of PDUs pending, etc.); the radio conditions toward the source drops below a certain configured threshold; and a certain configured time duration has elapsed.

The WTRU may then send information to the network about the release of the connection to the source (or request the network to release the connection to the source).

In NR, the WTRU may simultaneously receive DL data from both the source and the target during HO when configured with a DAPS bearer. The WTRU may release the connection with the source only after receiving an explicit release command (e.g., in an RRC Reconfiguration message) from the target.

In one embodiment, the WTRU may determine whether/when to release the connection with the source based on the status of DL reception of PDU sets and/or data bursts.

The connection with the source may refer to any of bearers, links, legs, or resources associated with the source, for example. The WTRU may reset any timers (e.g., RLC AM/UM timers) associated with the source bearers/link/leg when releasing the associated connection, for example. In one variant of the embodiment, the bearers/links/legs associated with the source considered for release are only those that are configured for DAPS HO. Such bearers/links/legs that may be released by the WTRU may be indicated to the WTRU via the DAPS HO command, for example.

In an example, the WTRU may release the connection with the source before receiving the explicit release indication from the target when certain conditions (described herein) are met. In another example, the WTRU may retain the connection with the source, possibly after receiving the release indication from target, until the conditions are met. Such conditions detected by the WTRU for determining whether/when to release the connection with the source for receiving DL traffic may include any of the following (a-i):

### a) Status of DL Reception:

For example, the WTRU may retain the connection with the source if the WTRU expects any reception of pending PDUs of a PDU set or data burst from the source.

The WTRU may release the source connection if the last PDU of a PDU set or data burst is received successfully and/or after transmission of an ARQ/HARQ ACK indication for the last PDU to the source.

The WTRU may retain the source connection if an ARQ/HARQ NACK indication is transmitted for the last PDU to the source, for example. The WTRU may retain the connection for a certain configured number of expected retransmissions, expiry of a configured timer after transmitting the NACK indication, or until successful reception of the last PDU, for example.

### b) Status of QoS (e.g., PSDB, TTL, Number/Percentage of Retransmissions at RLC/MAC, etc.):

For example, the WTRU may decide whether to release the connection with the source either immediately or after some time duration, upon receiving the release indication from the network, based on the status of a PDU set received so far and/or pending PDUs of the PDU set yet to be received. In an example, the WTRU may send a status report (e.g., PDCP status report, buffer status report) upon receiving the release indication from the network. Such status report may be sent if any timer (e.g., PDCP re-ordering timer) associated with the reception of PDUs of PDU set within QoS (e.g., PSDB) is running, for example. Such status report may contain information on the number or percentage of PDUs of a PDU set that have been received successfully, IDs of the PDUs received successfully (e.g., SNs), or PDUs of PDU sets that are missing (e.g., SNs), for example. In an example, after receiving the release indication, the WTRU may release the connection with the source immediately if the percentage of the PDUs yet to be received successfully is greater than or less than a threshold value (e.g., WTRU releases the source connection if less than (or more than) 40% of PDUs are yet to be received).

Otherwise, after receiving the release indication, the WTRU may retain the connection for a certain duration for receiving any pending/remaining PDUs (e.g., WTRU retains the source connection if only 10% of PDUs are yet to be received) before releasing the connection with source.

### c) Importance/Priority of PDU set:

For example, the WTRU may determine whether to release/retain the connection with the source based on the importance/priority of the PDU set or PDUs of a PDU set. For a PDU set marked with a low importance (e.g., below an importance threshold value), the WTRU may release the connection with the source, possibly after initiating RA or transmitting the RRC Reconfiguration Complete message to the target, even if some remaining PDUs of the PDU set are not received yet, for example). For a PDU set marked with high importance (e.g., above or equal to an importance threshold value), the WTRU may retain the connection with the source, possibly until the remaining PDUs of the PDU set are successfully received, even after receiving the release indication from the target, for example.

### d) Reception Time Duration/Window:

For example, the WTRU may be configured with a time duration/window during which the WTRU is expected to receive any DL data via the source and/or target. The WTRU may initiate a timer associated with the configured time window when triggering HO (e.g., after receiving HO command or initiating RA) and may switch to receiving any DL data including pending PDUs/PDU sets only via the target after the expiry of the time. If any of the conditions associated with successful HO are not met (e.g., HO failure), the WTRU may switch to the source for receiving the DL data, for example.

### E) Reception Periodicity:

For example, when receiving one or more PDU sets in the DL periodically with a configured periodicity, the WTRU may receive a first PDU set from the source during a first occasion and the second PDU set from the target during a second occasion. In this case, if the first PDU set is successfully received, the WTRU may release the connection with the source before receiving the second PDU set via the target. Otherwise, the WTRU may retain the connection with the source for receiving any remaining PDUs of the first PDU set via the source while receiving the PDUs of the second PDU set from the target.

### f) Reception of DL Data Expected From the Source From the Link/Leg Associated With the Target:

For example, the WTRU may first receive n out of N PDUs of a PDU set from the link/leg associated with the source. If the WTRU successfully receives the remaining N-n PDUs from the target, the WTRU may release the connection with the source.

### g) Inactivity of Source Link/Leg:

For example, the WTRU may release the connection with the source if the WTRU does not receive any DL data via the link/leg associated with the source for a certain configured time duration.

### h) Reception of Switching Indication:

For example, the WTRU may release the source connection when receiving an explicit or implicit switching indication (e.g., in RRC, MAC CE, DCI) indicating the path switch for delivery of any PDU sets and/or data bursts from the source to the target.

i) Radio Link Quality of the Source or/and Target:

For example, the WTRU may release the source connection when/if the radio signal level of the source falls below a certain threshold.

In one embodiment, the WTRU may be configured with timing information (e.g., in the DAPS HO command), indicating, e.g., for how long the source connection must be kept, the maximum duration the source connection can be kept, a window of time (e.g., minimum time the source should be kept and maximum time the source can be kept, etc. ,).

In one embodiment, the WTRU may perform the determination of when to release the connection to the source based on characteristics/conditions of pending UL PDU sets or data bursts.

In one embodiment, the WTRU may perform the determination of when to release the connection to the source based on characteristics/conditions of pending DL and UL PDU sets or data bursts.

In one embodiment, the WTRU, upon determining the conditions for releasing the source are fulfilled according to any of the embodiments above, may send an indication to the network, instead of or in addition to releasing the connection to the source.

### Representative Embodiments/Solutions Summary

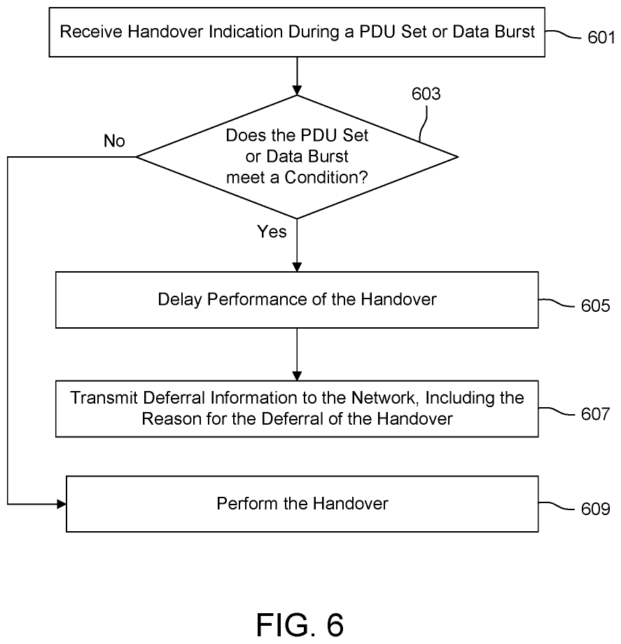

FIG. 6 is a flowchart illustrating an exemplary process for a WTRU to execute handover when interdependencies exist between data packet units data burst being transmitted when handover is triggered in accordance with embodiments.

In step 601, the WTRU receives a handover indication from the network while it is transmitting or receiving a PDU data set or data burst.

In step 603, the WTRU determines if a parameter related to the PDU set or data burst meets a condition. The condition may be as simple as whether the (transmission/reception of a) PDU set or burst is completed. Particularly, some PDU sets or data bursts may contain interrelated data, (e.g., XR data or video frame data, wherein the data in one frame is dependent on the data in a preceding frame, such that breaking op the transmission mid-stream may cause the latter part of the data to become useless).

If, in step 603, the condition is met (e.g., PDU set or burst is completed-yes), then flow proceeds to step 609 to perform the handover without intentional delay.

If, on the other hand, in step 603, the condition is not met (e.g., PDU set or burst is completed-no), then flow instead proceeds to step 605 wherein the handover is deferred until the condition is met.

Next, in step 607, the WTRU transmits to the network deferral information about the deferred handover, including the reason for the deferral of the handover.

In an embodiment, the handover may be a standard handover, a conditional handover, or a DAPS handover.

In an embodiment, condition for not deferring the handover may be as simple as the transmission of the PDU set or data burst is not completed.

In another embodiment, the condition for not deferring the handover may be that the radio signal level is above a certain threshold (As there is no sense in deferring the handover, if the data that is going to be transmitted to the source cell rather than the target cell is going to be of poor quality).

In yet other embodiments, the condition may be any one or more of: a size of the PDU set or data burst; an amount of data in the PDU set or data burst remaining to be transmitted; a percentage of data remaining in the PDU set or data burst remaining to be transmitted; a Quality of Service (QoS) of the PDU set or data burst meeting a threshold; a type of the data in the PDU set or data burst; a periodicity of the PSU set or data burst; an importance level of the data in the PDU set or data burst; and a buffer level of a radio bearer or Logic Channel (LCH) meeting a threshold.

In an embodiment, the method may further comprise, when a handover is deferred, commencing the handover when the condition is met.

In an embodiment, commencing handover may comprise initiating a Random Access (RA) procedure to the target or transmitting an RRC Reconfiguration Complete message to target.

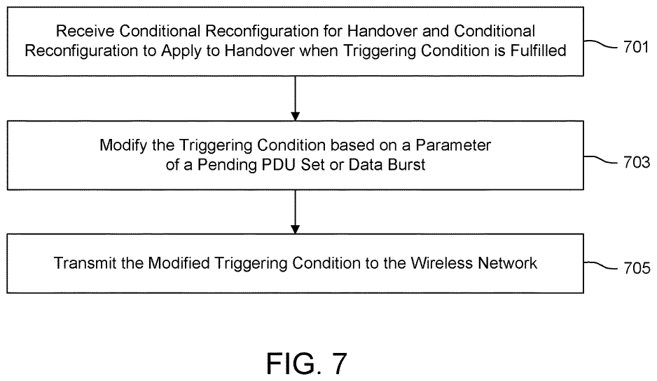

FIG. 7 is a flowchart illustrating an exemplary process for a WTRU to modify the CHO triggering conditions based on certain conditions related to ongoing PDU sets or data bursts further being fulfilled in accordance with embodiments.

In step 701 the WTRU receives a conditional reconfiguration comprising a radio related triggering condition for handover from a source cell to a target cell and conditional reconfigurations to apply to the handover when the triggering condition is fulfilled.

In step 703, the WTRU modifies the triggering condition based on a parameter of a pending PDU set or data burst.

In step 705, the WTRU transmits to the wireless network the modified triggering condition.

In an embodiment, the transmitting of the modified triggering condition to the network may further include transmitting a reason for the modification and information about execution of the reconfiguration.

In an embodiment, the triggering condition may be dependent on a PSDB of a data set that is being transmitted or received.

In an embodiment, the triggering condition may be a duration of a smallest PSDB of one or more PDU sets being transmitted or received.

In an embodiment, the triggering condition may be a duration of a smallest TTL of one or more PDU sets being transmitted or received.

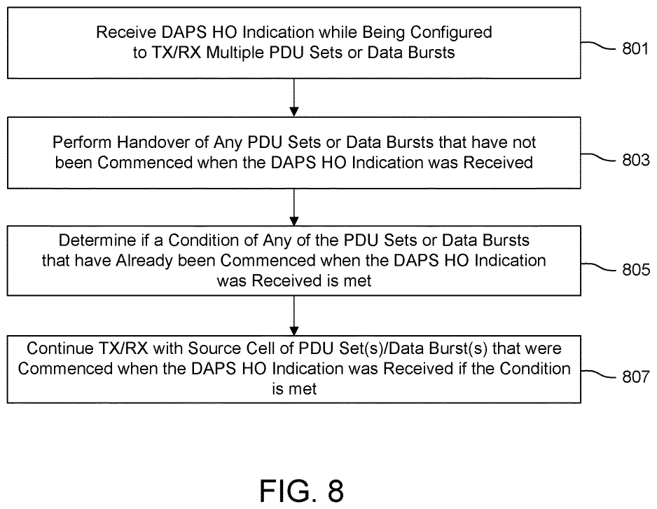

FIG. 8 is a flowchart illustrating an exemplary process for a WTRU to perform DAPS HO in accordance with embodiments.

In step 801, the WTRU receives from a network a Dual Active Protocol Stack (DAPS) Handover (HO) indication from a source cell to a target cell while the WTRU is configured to transmit or receive multiple PDU sets or data bursts.

In step 803, the WTRU performs the handover to the target cell of any of the multiple PDU sets or data bursts that have not been commenced/begun/started (e.g., of which transmission (reception) has not commenced/begun/started, e.g., not yet present in a transmission (reception) buffer associated with the transmission (reception), not yet transmitted but scheduled for transmission, not yet scheduled for transmission) when the DAPS HO indication was received.

In step 805, the WTRU determines whether a condition of any of the multiple PDU sets or data bursts that have already been commenced/begun/started (e.g., of which transmission (reception) has commenced/begun/started, e.g., present in a transmission (reception) buffer associated with the transmission (reception), scheduled for transmission but not yet transmitted, transmission (reception) ongoing) when the DAPS HO indication was received is met.

In step 807, the WTRU continuing to transmit or receive any of the multiple PDU sets or data bursts that have been commenced when the DAPS HO indication is received with the source cell if the condition is met.

In an embodiment, the condition is a size of the PDU set or data burst currently being transmitted or received.

In an embodiment, the condition may be a remaining number of PDUs to be transmitted in the PDU set or data burst currently being transmitted or received meeting a threshold.

In an embodiment, the condition may be a Quality of Service (QOS) of the PDU set or data burst currently being transmitted or received meeting a threshold.

In an embodiment, the condition may be a type of the PDU set or data burst currently being transmitted or received.

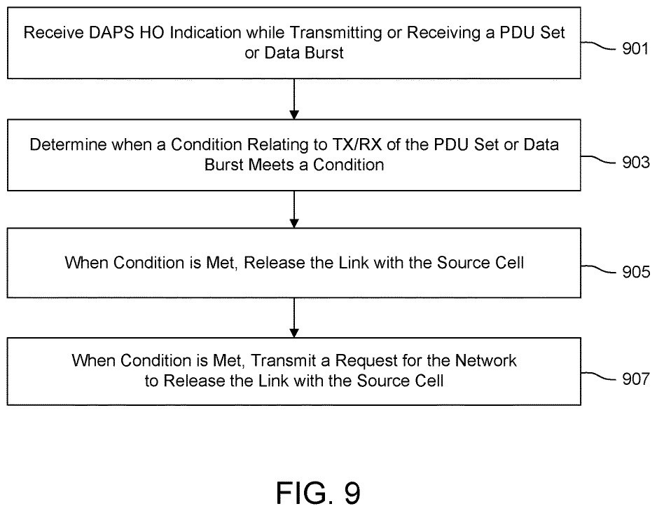

FIG. 9 is a flowchart illustrating an exemplary process for a WTRU to release radio resources to a source cell responsive to a handover in accordance with embodiments.

In step 901, the WTRU receives from a network a DAPS (HO) indication from a source cell to a target cell while transmitting or receiving a PDU set or data burst.

In step 903, the WTRU determines when a condition relating to transmission or reception of PDU set or data burst meets a condition.

In step 905, responsive to the condition being met, the WTRU releases the link to the source cell.

In step 907, responsive to the condition being met, the WTRU transmits to the wireless network a request for the network to release the radio link to with source cell.

In an embodiment, the condition may be transmission or reception of the PDU set or data burst is completed.

In an embodiment, the condition may be a radio condition of a radio link between the WTRU and the source cell.

In an embodiment, the condition may be a time period since the Dual Active Protocol Stack (DAPS) Handover (HO) indication was received.

In an embodiment, the condition may be one or more of: a function of a Quality of Service of the PDU set or data burst; a function of a priority level of the PDU set or data burst; expiration of a timer; and a radio link quality of a radio link with the source cell failing to meet a threshold.

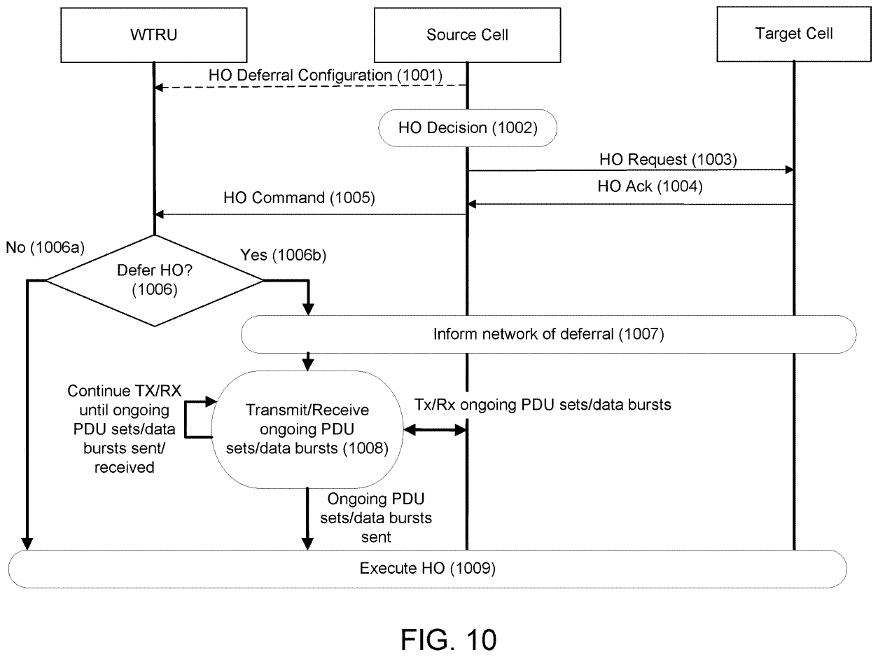

FIG. 10 is a sequence chart of an exemplary embodiment of a method for handover deferral of a WTRU from a source cell to a target cell.

In 1001, configuration information may be received by the WTRU. The configuration information is for example configuration information related to handover deferral/or configuration information that can be used for that purpose, for example described in previous section ‘configuration aspects’.

In 1002, the source cell may decide to handover the WTRU to a target cell.

In 1003, the source cell may transmit a handover request to the target cell.

In 1004, the target cell may transmit a handover acknowledgement.

In 1005, the source cell may transmit a handover command to the WTRU, see for example previous section ‘WTRU actions’ and FIG. 6 step 601 and its description in the present document.

In 1006, the WTRU may determine to defer the handover or not. See for example step 603 in FIG. 6 and its description.

In 1006a, if the WTRU has determined that the handover is not to be deferred, e.g., according to conditions for handover deferral as retrieved from the configuration information retrieved in 1001, the WTRU goes to step 1009.

In 1006b, if the WTRU has determined that the handover is to be deferred, e.g., according to conditions for handover deferral retrieved from the configuration information received in 1001; see also FIG. 6 step 605 and its description.

In 1007, the WTRU may inform the network of the handover deferral. See for example FIG. 6 step 607, and previous section ‘HO execution that considers ongoing PDU sets or data bursts’.

In 1008, the WTRU may transmit or receive an ongoing PDU set or data burst. See for example section ‘HO execution that considers ongoing PDU sets or data bursts’.

In 1009, the WTRU may execute the handover.

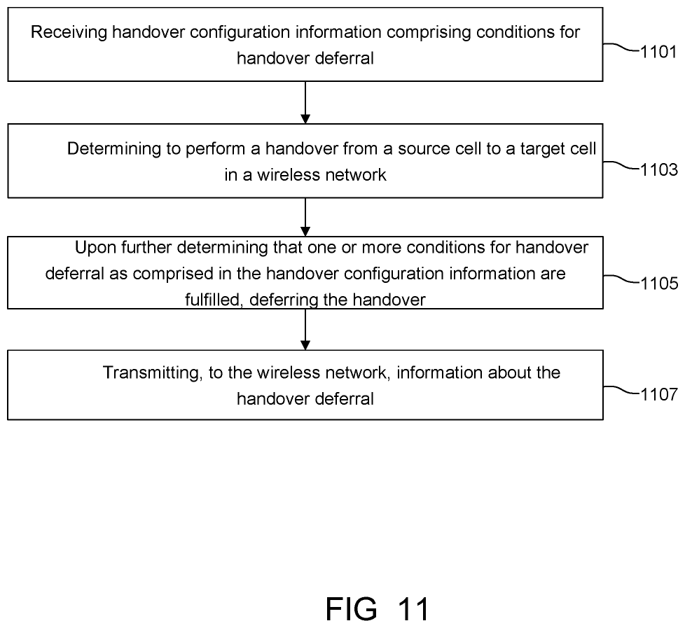

FIG. 11 is a flowchart of a method according to an exemplary embodiment.

The method is implemented in a wireless transmit-receive unit (WTRU) in a wireless network. The method may comprise:
In 1101, receiving handover configuration information comprising conditions for handover deferral;
In 1103, determining to perform a handover from a source cell to a target cell in the wireless network;
In 1105, upon further determining that one or more conditions for handover deferral as comprised in the handover configuration information are fulfilled, deferring the handover; and
In 1107, transmitting, to the wireless network, information about the handover deferral.

According to an embodiment, the information about the handover deferral comprises one or more a cause indications for the handover deferral.

According to an embodiment, the one or more cause indications are based on the one or more conditions for handover deferral that caused the handover deferral.

According to an embodiment, the handover is no longer deferred and performing the handover, if:
the one or more conditions for handover deferral are no longer fulfilled;
a time duration has elapsed since the determining to perform the handover.

According to an embodiment, the determining to perform the handover is based on reception of one of:
a handover command;
a handover indication; and
a dual active protocol stack (DAPS) handover command.

According to an embodiment, the one or more conditions for handover deferral are one or more of the following:
an ongoing transmission or reception of a protocol data unit (PDU) set or data burst;
a remaining data volume of an ongoing transmission or reception of a protocol data unit (PDU) set or data burst being relative to a threshold;
a percentage of a remaining data volume of an ongoing transmission or reception of a protocol data unit (PDU) set or data burst relative to a threshold;
an ongoing transmission or reception of a protocol data unit (PDU) set or data burst of an importance level;
a level of a radio signal between the WTRU and the source cell being higher than a radio signal level threshold; and
an amount of remaining data of an ongoing transmission or reception of a protocol data unit (PDU) set or data burst to be transmitted or received.

According to an embodiment, the one or more conditions for handover deferral are one or more of the following:
for an ongoing transmission of a protocol data unit (PDU) set or data burst, a size of the PDU set or of the data burst;
a type of an ongoing transmission or reception of a protocol data unit (PDU) set or data burst;
a quality of service (QoS) of an ongoing transmission or reception of a protocol data unit (PDU) set or data burst;
a type of data in the ongoing transmission or reception of a protocol data unit (PDU) set or data burst;
a periodicity of an ongoing transmission or reception of a protocol data unit (PDU) set or data burst;
an importance level of data in an ongoing transmission or reception of a protocol data unit (PDU) set or data burst; and
a buffer level of a radio bearer or logic channel (LCH).

According to an embodiment, performing the handover comprises one or more of:
initiating a random access (RA) procedure to the target cell; and
transmitting a radio resource control (RRC) reconfiguration complete message to the target cell.

There is also disclosed a wireless transmit-receive unit (WTRU) comprising at least one processor, wherein the at least one processor may be configured to:
receive handover configuration information comprising conditions for handover deferral;
determine to perform a handover from a source cell to a target cell in a wireless network;
determine that one or more conditions for handover deferral as comprised in the handover configuration information are fulfilled, deferring the handover; and
transmit, to the wireless network, information about the handover deferral.

According to an embodiment, the information about the handover deferral comprises one or more a cause indications for the handover deferral.

According to an embodiment, the one or more cause indications are based on the one or more conditions for handover deferral that caused the handover deferral.

According to an embodiment, the handover is no longer deferred and performing the handover, if:
the one or more conditions for handover deferral are no longer fulfilled;
a time duration has elapsed since determine to perform the handover.

According to an embodiment, determine to perform the handover is based on reception of one of:
a handover command;
a handover indication; and
a dual active protocol stack (DAPS) handover command.

According to an embodiment, the one or more conditions for handover deferral are one or more of the following:
an ongoing transmission or reception of a protocol data unit (PDU) set or data burst;
a remaining data volume of an ongoing transmission or reception of a protocol data unit (PDU) set or data burst being relative to a threshold;
a percentage of a remaining data volume of an ongoing transmission or reception of a protocol data unit (PDU) set or data burst relative to a threshold;
an ongoing transmission or reception of a protocol data unit (PDU) set or data burst of an importance level;
a level of a radio signal between the WTRU and the source cell being higher than a radio signal level threshold; and
an amount of remaining data of an ongoing transmission or reception of a protocol data unit (PDU) set or data burst to be transmitted or received.

According to an embodiment, the one or more conditions for handover deferral are one or more of the following:
for an ongoing transmission of a protocol data unit (PDU) set or data burst, a size of the PDU set or of the data burst;
a type of an ongoing transmission or reception of a protocol data unit (PDU) set or data burst;
a quality of service (QOS) of an ongoing transmission or reception of a protocol data unit (PDU) set or data burst;
a type of data in the ongoing transmission or reception of a protocol data unit (PDU) set or data burst;
a periodicity of an ongoing transmission or reception of a protocol data unit (PDU) set or data burst;
an importance level of data in an ongoing transmission or reception of a protocol data unit (PDU) set or data burst; and
a buffer level of a radio bearer or logic channel (LCH).

According to an embodiment, perform the handover comprises one or more of:
initiate a random access (RA) procedure to the target cell; and
transmit a radio resource control (RRC) reconfiguration complete message to the target cell.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.)

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 1 6 or means-plus-function claim format, and any claim without the terms “means for” is not so intended.

1. A method implemented in a wireless transmit-receive unit (WTRU) in a wireless network, the method comprising:
receiving handover configuration information;
determining to perform a handover from a source cell to a target cell in a-the wireless network, while there is an ongoing transmission or reception at the WTRU of a packet data unit (PDU) set, or of a data burst;
determining that one or more conditions, as comprised in
the handover configuration information, related to the ongoing transmission or reception of the PDU set or of the data burst are fulfilled, and deferring the handover; and
transmitting, to the wireless network, information about the handover deferral.

2. The method according to claim 1, wherein the information about the handover deferral comprises one or more a cause indications for the handover deferral.

3. The method according to claim 2, wherein the one or more cause indications are based on the one or more conditions that caused the handover deferral.

4. The method according to claim 1, comprising the handover is no longer deferred and performing the handover, if:
the one or more conditions are no longer fulfilled;
a time duration has elapsed since the determining to perform the handover.

5. The method according to claim 1, wherein the determining to perform the handover is based on reception of one of:
a handover command;
a handover indication; and
a dual active protocol stack (DAPS) handover command.

6. The method according to claim 1, wherein the one or more conditions are one or more of:
a remaining data volume of the ongoing transmission or reception of the PDU set or of the data burst being relative to a threshold;
a percentage of a remaining data volume of the ongoing transmission or reception of the PDU set or of the data burst relative to a threshold;
an importance level of the ongoing transmission or reception of the PDU set or of the data burst
a level of a radio signal between the WTRU and the source cell being higher than a radio signal level threshold; and
an amount of remaining data of the ongoing transmission or reception of the PDU set or of the data burst still to be transmitted or received.

7. The method according to claim 1, wherein the one or more conditions are one or more of:
for the ongoing transmission of the PDU set or of the data burst, a size of the PDU set or of the data burst;
a type of the ongoing transmission or reception of the PDU set or of the data burst;
a quality of service (QoS) of the ongoing transmission or reception of the PDU set or of the data burst;
a type of data in the ongoing transmission or reception of the PDU set or of the data burst;
a periodicity of the ongoing transmission or reception of the PDU set or of the data burst;
an importance level of data in the ongoing transmission or reception of the PDU set or of the data burst; and
a buffer level of a radio bearer or logic channel (LCH).

8. The method of claim 4, wherein performing the handover comprises one or more of:
initiating a random access (RA) procedure to the target cell; and
transmitting a radio resource control (RRC) reconfiguration complete message to the target cell.

9. A wireless transmit-receive unit (WTRU) in a wireless network, comprising at least one processor, wherein the at least one processor is configured to:
receive handover configuration information;
determine to perform a handover from a source cell to a target cell in the wireless network, while there is an ongoing transmission or reception at the WTRU of a packet data unit (PDU) set, or of a data burst;
determine that one or more conditions, as comprised in the handover configuration information, related to the ongoing transmission or reception of the PDU set or of the data burst are fulfilled, and deferring the handover; and
transmit, to the wireless network, information about the handover deferral.

10. The WTRU according to claim 9, wherein the information about the handover deferral comprises one or more a cause indications for the handover deferral.

11. The WTRU according to claim 10, wherein the one or more cause indications are based on the one or more conditions that caused the handover deferral.

12. The WTRU according to claim 9, wherein the handover is no longer deferred and perform the handover, if:
the one or more conditions are no longer fulfilled;
a time duration has elapsed since determine to perform the handover.

13. The WTRU according to claim 9, wherein determine to perform the handover is based on reception of one of:
a handover command;
a handover indication; and
a dual active protocol stack (DAPS) handover command.

14. The WTRU according to claim 9, wherein the one or more conditions are one or more of:
a remaining data volume of the ongoing transmission or reception of the PDU set or of the data burst being relative to a threshold;
a percentage of a remaining data volume of the ongoing transmission or reception of the PDU set or of the data burst relative to a threshold;
an importance level of the ongoing transmission or reception of the PDU set or of the data burst;
a level of a radio signal between the WTRU and the source cell being higher than a radio signal level threshold; and
an amount of remaining data of the ongoing transmission or reception of the PDU set or of the data burst still to be transmitted or received.

15. The WTRU according to claim 9, wherein the one or more conditions are one or more of:
for the ongoing transmission of the PDU set or of the data burst, a size of the PDU set or of the data burst;
a type of the ongoing transmission or reception of the PDU set or of the data burst;
a quality of service (QoS) of the ongoing transmission or reception of the unit PDU set or of the data burst;
a type of data in the ongoing transmission or reception of the PDU set or of the data burst;
a periodicity of the ongoing transmission or reception of the PDU set or of the data burst;
an importance level of data in the ongoing transmission or reception of the PDU set or of the data burst; and
a buffer level of a radio bearer or logic channel (LCH).

16. The WTRU of claim 12, wherein perform the handover comprises one or more of:
initiate a random access (RA) procedure to the target cell; and
transmit a radio resource control (RRC) reconfiguration complete message to the target cell.

17. The method according to claim 1, wherein the determining to perform a handover from a source cell to a target cell comprises the reception of a handover command from the source cell or a fulfillment of triggering conditions for a conditional handover.

18. The WTRU according to claim 9, wherein determine to perform a handover from a source cell to a target cell comprises a receipt of a handover command from the source cell or a fulfillment of triggering conditions for a conditional handover.
